(19) United States
(12) Patent Application Publication
(10) Pub. No.: US 2003/0140077 A1
(43) Pub. Date: Jul. 24, 2003

(54) Logic circuits for performing modular multiplication and exponentiation

(76) Inventors: Oleg Zaboronski, Coventry (GB); Peter Meulemans, Leamington (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 10/027,237

(22) Filed: Dec. 20, 2001

(30) Foreign Application Priority Data
Dec. 18, 2001 (GB) 0130255.3

(51) Int. Cl. G06F 7/38

(52) U.S. Cl. 708/491

(57) ABSTRACT

A logic circuit for performing modular multiplication of a first multi-bit binary number and a second multi-bit binary number is provided. Combination logic combines the second multi-bit binary value with a group of W bits of the first multi-bit binary value every j^{th} input cycle to generate W multi-bit binary combination values every j^{th} input cycle, where the W bits comprise bits jW to (jW+W−1), W>1, j is the cycle index from 0 to k−1, k=N/W, and N is the number of bits of the first multi-bit binary value. Thus in this way a plurality of multi-bit binary combinations are input every cycle in a parallel manner. Accumulation logic holds a plurality of multi-bit binary values accumulated over previous cycles. Reduction logic generates a W bit value Λ in a current cycle for use in the next cycle. A multi-bit modulus binary value is received and combined with the W bit value Λ generated in a current cycle to generate W multi-bit binary values for use in the next cycle. Combination logic receives the combinations from the combination logic and the W multi-bit binary values from the reduction logic as well as the binary values held by the accumulator logic to generate new multi-bit binary values for input to the accumulator logic to be held for the next cycle. The reduction logic generates the W bit value Λ based on the multi-bit modulus binary value, the multi-bit binary values held in the accumulator logic, W multi-bit binary combination values generated by the combination of the second multi-bit binary value and a group of W bits of the first multi-bit binary value in the current cycle, and the W bit value Λ generated for the current cycle.

### FIELD OF THE INVENTION

The present invention generally relates to logic circuits for performing modular multiplication and exponentiation, and in particular to the use of a logic circuit for performing Montgomery multiplication and the use of such a logic circuit in a logic circuit for modular exponentiation.

### BACKGROUND OF THE INVENTION

Modular exponentiation is an operation that is a common operation for scrambling. It is used in several cryptosystems. For example, the Diffie-Hellman key exchange system requires modular exponentiation. Also, the El Gamal signature scheme and the Digital Signature Standard (DSS) of the National Institute for Standards and Technology also require the computation of modular exponentiation. Further, the RSA algorithm also uses modular exponentiation. The RSA algorithm is one of the simplest public-key cryptosystems. The parameters are m, p and q, e and d. The modulus m is the product of the distinct large random primes: m=pq. The exponent e is a public key and comprises a multi-bit binary number. d is a private key and also comprises a large multi-bit binary number.

For a message m, encryption using the RSA algorithm is performed by computing:

C=M^{e}|mod m:

where C is the cipher text for the plain text M.

M can be deciphered using:

M=C^{d}|mod m.

In order to make the RSA algorithm secure, the numbers must be large, e.g. the modulus m is a positive integer ranging from 512 to 2048 bits. The public exponent e is a positive integer of small size, e.g. not usually more than 32 bits. The secret exponent d is a positive integer which is a large number.

It can thus be seen that when using the RSA algorithm, the modular exponentiation operation involves a large number of multiplications: particularly in view of the large size of the secret exponent d. When the size of the binary values being multiplied is large, the conventional multiplication technique of shifting and adding is not efficient.

There are many prior art techniques known for implementing modular exponentiation using the RSA algorithm and these techniques are reviewed in an article by Cetin Kaya Koc entitled “RSA Hardware Implementation” (RSA Laboratories, RSA Data Security Inc.) available at ftp://ftp.rsasecurity.com/pub/pdfs/tr801.pdf.

One known prior art technique involves the use of the Montgomery algorithm. One of the most efficient methods to perform modular exponentiation is based on the Montgomery reduction. If m is an N bit odd integer (for example an RSA modulus) and A is a 2N bit number less than m², then the Montgomery reduction of A is by definition (A2^{-N})|mod m. Here 2^{-N} is an integer, inverse to 2^{N} modulo m, i.e.

2^{-N}2^{N}=1+Xm,

where X is an integer.

Now let x and y be two N bit numbers less than m. The Montgomery product MP(x,y) of x and y is by definition the Montgomery reduction of xy:

MP(x,y)=(xy 2^{-N})|mod m.

It is well known that Montgomery reduction can be computed efficiently without any trial division used in conventional modular reduction algorithms. It is also well known that the multiplication and reduction steps in the computation of the Montgomery product (MP) can be effectively interleaved which speeds up the computation even further.

Now the prior art algorithm for the interleaved computation of the MP will be explained. MP(x,y) is computed iteratively in N cycles. Each cycle consists of a multiplication step followed by a reduction step. Let A=(A_{N-1}A_{N-2} . . . A₀) be an N bit accumulator register containing the intermediate result. Let (x_{N-1}x_{N-2} . . . x₀) and (y_{N-1}y_{N-2} . . . y₀) be the binary representations of x and y, respectively. The multiplication step of the i-th cycle consists of adding the N bit number xᵢy to A. The reduction step consists of finding a one-bit number λ such that A+λm is divisible by 2, adding λm to A and dividing A by 2. Division by 2 is just a single right shift and the updated value of the accumulator is

(A+λm)/2=A2⁻¹|mod m,

where 2⁻¹ is an integer which is inverse of 2 modulo m. Obviously, λ=A₀, as m is an odd integer. It is important to remark that after the N-th cycle of the MP algorithm the content of the accumulator A is a number which is:

Equal to MP(x,y) modulo m;

Less than 2 m.

Therefore the final reduction step consists of at most one subtraction of m from A.

The prior art MP algorithm can be represented in pseudo code as:

Input: m=(m_{N-1} . . . m₁ m₀) (binary representation)

x=(x_{N-1} . . . x₁x₀) (binary representation)

y=(y_{N-1} . . . y₁y₀) (binary representation)

R=2^{N}

0≦x,y<m, m is odd, m<R.

Output: MP(x,y)=xyR⁻¹ mod m

1) A←0 (A=(a_{N} . . . a₁a₀))

2) Cycle: j=0, . . . , N−1:

2.1λ=(a₀+xⱼy₀)mod 2=a₀⊕xⱼy₀

2.2 A←(A+xⱼy+λm)/2

3) If A≧m then A←A−m

4) Return A

The prior art MP algorithm can be implemented in a straightforward way. To avoid the full carry propagate additions at each cycle one uses a redundant representation of the accumulator A, as the sum of two N bit numbers, S=(S_{N-1}S_{N-2}. . . S₀) and C=(C_{N-1}C_{N-2} . . . C₀). Then in the j-th cycle of the algorithm, the following array is reduced and shifted, resulting in the updated values of S and C:

| | S_{N-1} | | S₂ | S₁ | S₀ |
|---|---|---|---|---|---|
| C_{N-1} | . . . | C₂ | C₁ | C₀ | |
| xⱼY_{N-1} | | Xⱼy₂ | xⱼy₁ | xⱼy₀ | |
| | | | | + | |
| 0 | U_{N-1} | | U₂ | U₁ | U₀ |
| V_{N} | V_{N-1} | . . . | V₂ | V₁ | 0 |
| 0 | λm_{N-1} | | λm₂ | λm₁ | λ |
| | | | | | + |
| S_{N-1} | S_{N-2} | . . . | S₁ | S₀ | 0 |
| C_{N-1} | C_{N-2} | | C₁ | C₀ | 0 |

Here λ=U₀. This table shows the reduction of the array in two steps. The first step reduces first three rows to two (the fourth and fifth row). The second step takes these two values and a third, λm, and reduces them to two (the bottom two rows). The reduction from 3 to 2 numbers is in hardware performed using Full Adders (FAs). The result in the last two rows is finally shifted one place to the right, which corresponds to the division by two in step 2.2 of the algorithm.

The overall layout of the implementation is shown in FIG. 1. It consists of N processing elements 1, each connected to its nearest neighbours, and to the 0-th processing element via two buffer trees 2. The purpose of the buffer tree 2 is to distribute λ and xⱼ to all N processing elements. Since N is in practice a large number (e.g. 1024 in RSA applications), a tree structure of buffers 2 is needed to reduce the delay of distributing the signals, due to the high total capacitance of N processing elements 1.

First the structure of each processing element 1 and their interactions will be discussed. Then the flow of data through the implementation as it computes the MP(x,y) will be discussed.

FIG. 2 shows the logical structure of a processing element. It contains three flipflops. Two flipflops (S and C) of the i-th processing element store Sᵢ and Cᵢ, the i-th bits of the redundant intermediate result. The third flipflop of the i-th processing element contains xᵢ₊ⱼ, at the j-th cycle, where by definition the value of xₖ is 0 for k≧N. Each flipflop is fed by a multiplexer, which ensures that the correct initial values can be loaded before the first cycle, by enabling the ‘load’ input. For the multiplication step of the algorithm, there is an AND gate to compute xⱼyᵢ and a full adder to reduce Sᵢ+Cᵢ+xⱼyⱼ to Uᵢ+2Vᵢ₊₁. For the reduction step of the algorithm, there is an AND gate to compute λmᵢ and a full adder to reduce Uᵢ+Vᵢ+λmᵢ to Sᵢ₋₁+2Cᵢ.

The i-th processing element feeds its output Xᵢ into the (i−1)-th processing element, and therefore receives its input Xᵢ₊₁, from the (i+1)-th processing element. This ensures that the 0-th processing element contains xⱼ at the start of the j-th cycle of the algorithm. The i-th processing element feeds its output Vᵢ₊₁ into the (i+1)-th processing element, and therefore receives its input Vᵢ from the (i−1)-th processing element. The i-th processing element feeds its output Sᵢ₋₁ into the (i−1)-th processing element. The carry Cᵢ feeds back into the C flipflop of the same processing element. These two feedbacks correspond to the right shift (division by 2) in the algorithm. The inputs yᵢ and mᵢ of i-th processing element are connected to the corresponding registers storing y and m. The X and Λ inputs of the i-th processing element are connected to X and Λ buffer trees 2, respectively. The initial values of the S, C and X flipflops are 0, 0 and xᵢ, respectively.

The connections to the 0-th processing element differ from the above in the following way. Its inputs V₀ are always 0 and its output ‘S₋₁’ is also always zero and does not feed into anything. Its X₀ output feeds into the X buffer tree, to deliver xⱼ to all processing elements at the start of the j-th cycle. The sum output of its first full adder (U₀) feeds into the Λ buffer tree 2, to deliver λ to all processing elements during the j-th cycle.

The flow of data for the computation of one Montgomery product is as follows. Before the first cycle starts, the initial values are loaded into the flipflops, by means of the multiplexers. At each cycle the xᵢ's shift one position to the right, such that the X flipflop of the 0-th processing element 1 contains xⱼ at the start of the j-th cycle. In the process of the cycle xⱼ is delivered to all processing elements via the X buffer tree 2; xⱼyᵢ+Sᵢ+Cᵢ is reduced to Uᵢ+2Vᵢ₊₁ by the first fall adder in the i-th processing element. Uᵢ is then fed into the second fall adder of the i-th processing element, while Vᵢ₊₁ is fed into the second full adder. U₀ is fed into the Λ buffer tree 2 and delivered to the second AND gate of each processing element. The second fall adder of the i-th processing element then reduces Uᵢ+Vᵢ+λmᵢ to Sᵢ₋₁+2Cᵢ. Cᵢ is then fed into the C flipflop of the i-th processing element and Sᵢ₋₁ is fed into the S flipflop of the (i−1)-th processing element, thus incorporating the division by 2. After the N-th cycle, the outputs S and C must be added and the final reduction (step 3 of the algorithm) has to be performed.

FIG. 3 is a schematic diagram showing the functional units to implement the prior art Montgomery product algorithm. The inputs XⱼYⱼ comprise an array of multi-bit binary combinations. Each row of the array represents the multiplication of a first number Y₁ by one bit of the second binary number Xⱼ. The array can thus be represented as a parallelogram. In the algorithm at each cycle one row of the array is input, i.e. a single multi-bit binary combination value is input to multiplication/reduction logic 3 which comprises fall adder logic 4 and full adder reduction logic 5. The fall adder logic 4 also receives previous outputs from the multiplication/reduction logic 3 (stored in the flip-flops) CᵢSᵢ. The full adder logic 4 generates an output Λ which is combined by addition with an input modulus M before being input into the full adder logic 5.

Thus the multiplication/reduction logic 3 performs step 2 of the algorithm in a cyclical manner for the j rows of the array. When all of the rows of the array have been processed, i.e. j=N−1, the outputs of the full adder logic 5 Cᵢ and Sᵢ are input into final reduction logic 6 to output the Montgomery product A. The final reduction logic 6 includes adder chain logic 7 to add the two outputs Cᵢ and Sᵢ to generate an intermediate value A. Subtraction logic 8 then performs a comparison of the intermediate value A with the modulus M and subtracts the modulus M if the intermediate value A is not less than M. Thus the final reduction logic 6 performs step 3 of the prior art Montgomery product algorithm.

The major disadvantage of the prior art implementation is its sequential nature. Within each cycle of the algorithm the array is reduced in the slowest fashion possible, i.e. by one row at a time. If it were attempted to speed up the algorithm to a straightforward parallelization, this would fail due to a special nature of the Montgomery product. Suppose that two N bit Montgomery multipliers were employed working in parallel to compute the Montgomery product MP (A, B), then after N/2 cycles they will produce (AB2^{-N/2})|mod m instead of (AB2^{-N})|mod m, i.e. N/2 more cycles are needed to complete the reduction. Hence this parallelization and hence increase of chip area does not reduce the numbers of cycles needed.

### SUMMARY OF THE INVENTION

It is an object of one aspect of the present invention to provide a logic circuit which can perform modular multiplication in reduced cycles by utilizing parallelization.

It is an object another aspect of the present invention to provide a logic circuit for modular exponentiation which employs logic units for performing modular multiplication for which a degree of parallelization is implemented.

One aspect of the present invention provides a logic circuit for performing modular multiplication, comprising: a logic input for accessing combinations of two binary inputs to input W multi-bit binary combinations of two binary numbers, where W>1; accumulator logic for accumulating multi-bit binary values; combining logic for combining the input W multi-bit binary combinations and the values in the accumulator logic to generate new values for input to the accumulator logic; and reduction logic for determining a W bit binary value A|mod 2^{W}, for receiving a multi-bit modulus binary value, and for generating W multi-bit binary values using the W bit binary value and the modulus binary value; wherein said combination logic is arranged to generate the new values by also including the generated W multi-bit binary values.

Another aspect of the present invention provides a logic circuit for performing modular multiplication of a first multi-bit binary number and a second multi-bit binary number. Combination logic combines the second multi-bit binary value with a group of W bits of the first multi-bit binary value every j^{th} input cycle to generate W multi-bit binary combination values every j^{th} input cycle, where the W bits comprise bits jW to (jW+W−1), W>1, j is the cycle index from 0 to k−1, k=N/W, and N is the number of bits of the first multi-bit binary value. Thus in this way a plurality of multi-bit binary combinations are input every cycle in a parallel manner. Accumulation logic holds a plurality of multi-bit binary values accumulated over previous cycles. Reduction logic generates a W bit value Λ in a current cycle for use in the next cycle. A multi-bit modulus binary value is received and combined with the W bit value Λ generated in a current cycle to generate W multi-bit binary values for use in the next cycle. Combination logic receives the combinations from the combination logic and the W multi-bit binary values from the reduction logic as well as the binary values held by the accumulator logic to generate new multi-bit binary values for input to the accumulator logic to be held for the next cycle. The reduction logic generates the W bit value Λ based on the multi-bit modulus binary value, the multi-bit binary values held in the accumulator logic, W multi-bit binary combination values generated by the combination of the second multi-bit binary value and a group of W bits of the first multi-bit binary value in the current cycle, and the W bit value Λ generated for the current cycle.

Thus in accordance with this aspect of the present invention, a degree of parallelization is provided by inputting W rows of the array at each iteration or cycle of the modular multiplication process. The ability to input more than one row at a time requires generation of a W bit value Λ rather than the single bit λ in the prior art.

The parallelization can be achieved by predetermining a factor Λ in a previous cycle which will cause the W least significant bits of the update for the accumulator generated in the current cycle to be zeros. This allows a W bit shift of the update before loading into the accumulator for use in the next cycle in a manner similar to the prior art Montgomery multiplication technique.

In one embodiment the reduction logic is arranged to generate the W bit value Λ for the next cycle to make the least significant bits of the plurality of new multi-bit binary values generated by the combination logic in the next cycle 0, and the combination logic includes shift logic to shift the generated new multi-bit binary values by W bits before input to the accumulator logic. Thus this generation of the W bit value Λ ensures that the combination of the inputs generated by the combination logic is divisible by 2^{W} so that the accumulator values can be shifted by W bits ready for combination with the next group of multi-bit combination values from the array.

In one embodiment the reduction logic is arranged to generate the W bit value Λ for the next cycle based on the 2W least significant bits of the multi-bit modulus binary value, the 2W least significant bits of the multi-bit binary value held in the accumulator logic in the current cycle, the jW to (jW+W−1) bits of the W multi-bit binary combination values generated by a combination of the second multi-bit binary value and a group of W bits of the first multi-bit binary value in the current cycle, and the W bit value Λ generated by the generation logic for the current cycle. Thus the generation of Λ for the next cycle is only dependent upon the 2W least significant bits. Therefore, in order to speed up computation, in one embodiment pre-combination logic can be provided for receiving and combining the second multi-bit binary value and the jW to (jW+W−1) bits of the first multi-bit binary value in the current cycle to generate a single multi-bit binary combination value for input to the reduction logic for use in the next cycle.

Since only the 2W least significant bits need to be pre-calculated in this manner, fast logic can be used to make the combination value available for the calculation of Λ in the next cycle, thus avoiding the calculation of Λ from slowing up the processing.

In one embodiment the input combination logic is connected to the reduction logic to input to the W multi-bit binary combination value to the reduction logic. In this embodiment the reduction logic does not form its own combination values.

In an alternative embodiment of the present invention, the reduction logic includes further input combination logic for receiving and combining the second multi-bit binary value and the group of W bits of the first multi-bit binary value in the current cycle to generate the W multi-bit binary combination values. Thus in this embodiment of the present invention, the reduction logic does not rely on the combination logic to provide the combination and instead provides its own combination logic for the generation of the required combination values for the generation of Λ.

In one embodiment of the present invention the combination logic is arranged to multiply the second multi-bit binary value and a group of W bits of the first multi-bit binary value every j^{th} input cycle to generate the W multi-bit binary combination values every j^{th} input cycle. Thus in this way the combination logic generates the W rows of the array required for input. In one embodiment the combination logic can comprise an array of AND logic gates.

In one embodiment of the present invention, the reduction logic is arranged to generate the W multi-bit binary values for use in the next cycle by multiplying the multi-bit modulus binary value with the W bit value Λ generated in a current cycle. In one embodiment the multiplication can be performed by an array of AND gate logic.

In an embodiment of the present invention, the combination logic includes a plurality of parallel counters for performing the combination. The parallel counters can be arranged to each receive a corresponding bit of: the multi-bit binary combinations generated by the input combination logic in the current cycle, the W multi-bit binary values generated by the reduction logic in the current cycle, and the multi-bit binary values held by the accumulator logic. In one embodiment each parallel counter has (2W+R) inputs and R outputs, where R is the number of new multi-bit binary values input to the accumulator logic to be held in the next cycle.

In an embodiment of the present invention the accumulator logic comprises an array of flip-flops, where each flip-flop receives a bit of one of the new multi-bit binary values output from the combination logic.

In order to ensure that the calculation of Λ does not slow the processing, in one embodiment of the present invention the reduction logic comprises high speed logic components.

In one embodiment the reduction logic includes a plurality of parallel counters for the generation of the W bit binary value Λ.

In one embodiment of the present invention the logic circuit includes final reduction logic for summing of the plurality of new multi-bit binary values output from the combination logic at the end of the (k−1)^{th} cycle and for subtracting the multi-bit modulus binary value from the sum if the sum is greater than or equal to the multi-bit modulus binary value. Thus in this embodiment of the present invention, at the end of the reduction process a final reduction step takes place which reduces the value to less than the modulus.

In one embodiment of the present invention, the multi-bit modulus binary value is an odd number. This is evident since the modulus is the product of two prime numbers p and q.

In an embodiment of the present invention the logic circuit is arranged to perform Montgomery multiplication. Thus the Montgomery product of A and B is:

MP(A.B)=A·B·2^{-N}|mod m

In one embodiment of the present invention, the modulus used by the logic circuit can be initially modified using modifying logic to set the W least significant bits to 1 s. This equates to multiplying the modulus m by a factor x which is between 0 and 2^{W}−1. The modification of the modulus in this way simplifies the calculation of Λ. At the end of the processing of the input array combination, i.e. at the end of the j^{th} cycle, the output needs to be converted back to modulus m. This can be achieved by subtracting m from the output until the output is <m. The number of subtractions required can be from 0 to 2^{W-}1. Alternatively it can be achieved by a logic circuit performing an equivalent function comprising a Montgomery multiplier receiving the original modulus.

In another embodiment of the present invention, the modulus can initially be modified by making the W to 2W−1 bits 0. In other words, the modulus m is multiplied by a factor x which can be anything from 0 to 2^{2W}−1. The setting of the bits from W to 2W−1 to 0 greatly simplifies the combination required for calculating Λ since combination values Λ and m input to the combination logic for the bits W to 2W−1 will be 0 and can thus be ignored. This reduces the number of inputs required for combination logic in the reduction logic used for calculating Λ, e.g. smaller parallel counters can be used. When the modulus is modified in this way, a final step of the algorithm after the j^{th} iteration requires the subtraction of m repeatedly until the output is <m. This subtraction can be required to be carried out 2^{2W}−1 times in order to remove the factor x. Alternatively to repeated subtraction, a logic circuit performing an equivalent function can be used, e.g. a Montgomery multiplier receiving the original modulus as the modulus.

One embodiment of the present invention provides modular exponentiation logic for performing modular exponentiation. The logic receives a multi-bit binary value to be exponentiated, a multi-bit binary exponent, and a multi-bit modulus binary value. At least one logic circuit for performing modular multiplication is included and is used to multiply the multi-bit binary value to be exponentiated. A multi-bit binary value comprising the modular exponentiation of the multi-bit binary number to be exponentiated is formed on the basis of an output of the or each logic circuit.

In one embodiment, the logic circuit performs Montgomery multiplication and thus an initial input multi-bit binary value of 2^{2N}|mod m is input into at least one logic circuit, where m is the multi-bit binary modulus value and N is the number of bits of the multi-bit binary modulus value. The multi-bit binary value to be exponentiated is initially input together with the value 2^{2N}|mod m into at least one of the logic circuits.

This process negates the effect of the factor 2^{-N} in the Montgomery product to enable the exponentiation process to generate the exponentiation of c by the exponent: d modulo m, i.e. c^{d}| mod m rather than the exponentiation of c by the exponent: d times 2^{-N} modulo m, i.e. c^{d}N^{-N}| mod m.

In one embodiment of the present invention, in order to simplify the calculation of Λ by the or each logic circuit, the modulus used by the or each logic circuit is initially modified by a factor to make the W least significant bits 1 s. In other words the modulus m is multiplied by factor X which is between 0 and 2^{W}−1.

In another embodiment of the present invention, in order to reduce the number of values to be combined by the combination logic in the or each logic circuit, the modulus used by the or each logic circuit is initially modified to make the W to 2W−1 bits 0. Since these bits are set to 0, and they are used to generate W multi-bit combination values by the reduction logic, the bits W to 2W−1 bits used in the determination of Λ will be set to 0 and can be ignored in the determination of Λ. This reduces the size of the combination logic in the reduction logic.

The logic circuit in accordance with the present invention can be used in an encryption logic circuit such as an RSA encryption circuit. The logic circuit can also be provided as an integrated circuit or an electronic device.

The logic circuit of the present invention can further be embodied as code defining characteristics of the logic circuit carried by any suitable carrier medium. The carrier medium can comprise a storage medium such as floppy disk, CD-ROM, hard disk, magnetic tape device, or solid state memory device, or a transient medium such as any type of signal, e.g. an electrical, optical, microwave, acoustic, or electromagnetic signal, e.g. a signal carrying the code over a computer network such as the Internet.

Another aspect of the present invention provides a method and system for designing a logic circuit as hereinabove described in which a computer program is implemented to generate information defining characteristics of the logic circuit in a computer system. In one embodiment the information is generated as code. The present invention thus also encompasses a carrier medium carrying computer readable code for controlling a computer to implement the method and system for designing the logic circuit. The carrier medium can comprise any suitable storage or transient medium.

Another aspect of the present invention provides a method of manufacturing a logic circuit as hereinabove described in which the logic circuit is designed and built in the semiconductor material in accordance with code defining characteristics of the logic circuit.

Another aspect of the present invention provides a logic circuit for performing Montgomery multiplication between a first multi-bit binary value and a second multi-bit binary value, comprising: input logic for inputting W multi-bit combination binary values comprised of the combination X_{jW}Yᵢ to X_{(jW+W-1)}Yᵢ of jW to (jW+W−1) bits of the first binary value X and i bits of the second multi-bit binary value, where j is the processing cycle from 0 to k−1, k=N/W, W>1, and N is the number of bits of the first multi-bit binary value; accumulator logic for accumulating at least one multi-bit binary value A in a current cycle on the basis of multi-bit binary values in the accumulator in a previous cycle, and the input W multi-bit combination binary values; and reduction logic for generating a W bit binary value Λ for a current cycle such that Λ=A|mod2^{W}, wherein said accumulator logic is arranged to update said at least one accumulated multi-bit binary value A for a current cycle by adding the product of the generated W bit binary value Λ and a multi-bit binary modulus value and dividing the result by 2^{W}.

In one embodiment of this aspect of the present invention, final reduction logic is included for determining a Montgomery product by subtracting the multi-bit modulus value from the accumulated multi-bit binary value or the sum of the accumulated multi-bit binary values if the accumulated multi-bit binary value or the sum of the accumulated multi-bit binary values is greater or equal to the multi-bit binary modulus value.

In another embodiment of the present invention, the accumulator logic is arranged to accumulate the or each multi-bit binary value A in a current cycle as A+X_{jW}Yᵢ+2X_{jW+1}Yᵢ+ . . . +2^{W-1}X_{(jW+W-1)}Yᵢ.

In another embodiment of the present invention the reduction logic is arranged to determine the W bit binary value for the next cycle based on the W bit binary value for the current cycle, the or each accumulated multi-bit binary value in the accumulator logic in the current cycle, the multi-bit binary modulus value, and the input W multi-bit combination binary values in the current cycle.

In another embodiment of the present invention the reduction logic and the accumulator logic are arranged to operate in parallel during the cycle.

Another aspect of the present invention provides a modular exponentiation logic circuit for performing modular exponentiation. Input logic receives a multi-bit binary value to be exponentiated, a multi-bit binary exponent, and a multi-bit modulus binary value. At least one logic circuit as described hereinabove is provided for performing modular multiplication using the input multi-bit binary value to be exponentiated.

### BRIEF DESCRIPTION OF THE DRAWINGS

Embodiments of the present invention will now be described with reference to the accompanying drawings in which:

FIG. 1 is a schematic diagram of a prior art Montgomery multiplier;

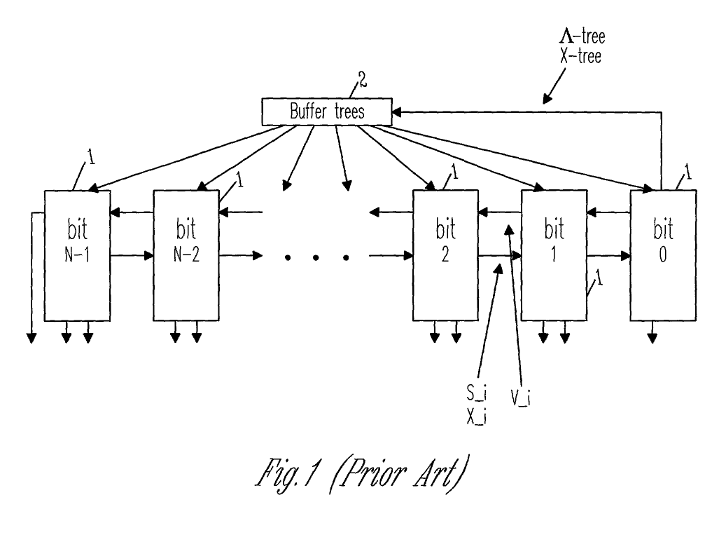

FIG. 2 is a diagram of the logic in a processing element in the prior art Montgomery multiplier of FIG. 1;

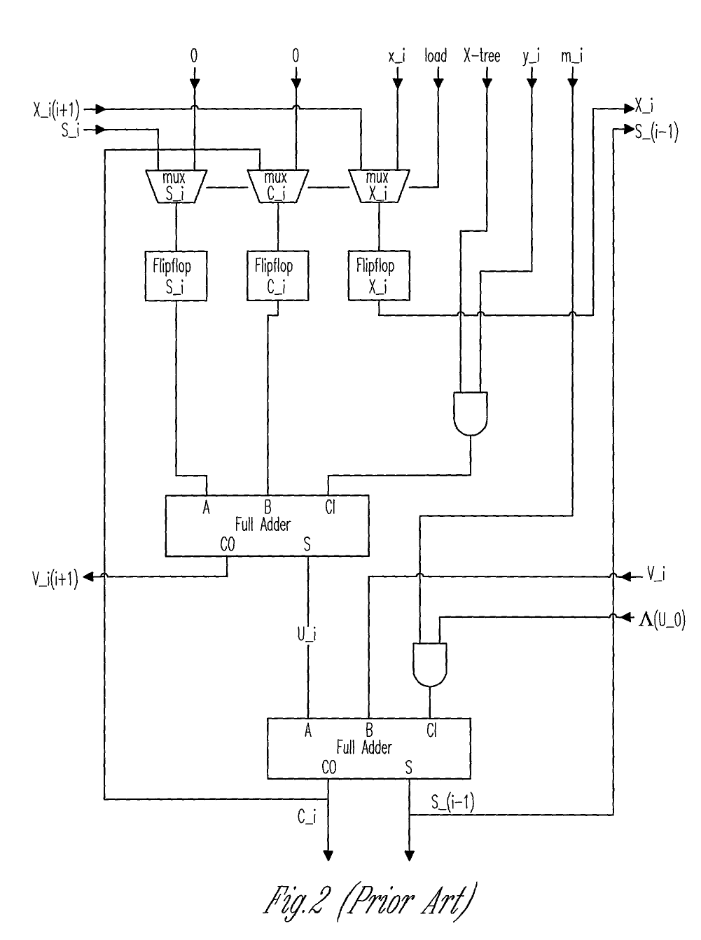

FIG. 3 is a schematic diagram of the prior art Montgomery multiplier showing the logic functions;

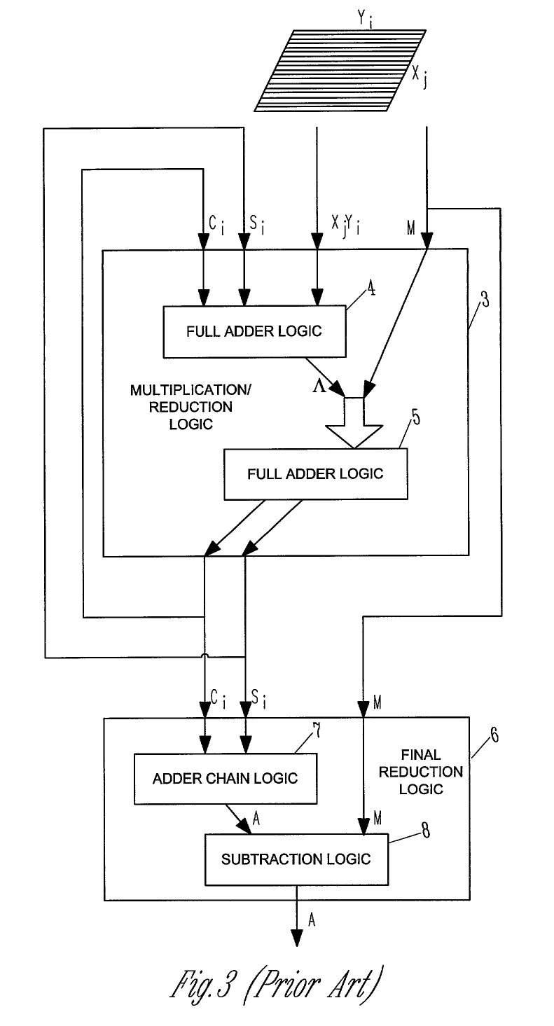

FIG. 4 is a schematic diagram of a Montgomery multiplier showing logic functions in accordance with one embodiment of the present invention;

FIG. 5 is a schematic diagram of a Montgomery multiplier in accordance with an embodiment of the present invention;

FIG. 6 is a diagram of the logic of a processing element in the Montgomery multiplier of FIG. 5;

FIG. 7 is a schematic diagram of the Λ logic unit (the reduction logic unit);

FIG. 8 is a diagram of the Λ logic in the Λ logic module of FIG. 7 in accordance with an embodiment of the present invention;

FIG. 9 is a schematic diagram of the logic for generating the Montgomery product A in accordance with an embodiment of the present invention;

FIG. 10 is a schematic diagram of a Montgomery multiplier in accordance with another embodiment of the present invention in which four rows of the array are processed in parallel, i.e. W=4;

FIG. 11 is a diagram of the logic in a processing element in the embodiment of FIG. 10;

FIG. 12 is a diagram of the Λ logic unit in the embodiment of FIG. 10;

FIG. 13 is a diagram of the logic block in the embodiment of FIG. 12;

FIG. 14 is a diagram of the CC1, CC2 logic block in the embodiment of FIG. 13;

FIG. 15 is a functional diagram illustrating the modular exponentiation process in accordance with an embodiment of the present invention;

FIG. 16 is a functional diagram illustrating the modular exponentiation process using the modified modulus in accordance with an embodiment of the present invention; and

FIG. 17 is a diagram illustrating the scheme for pre-computation of the modified modulus.

### DETAILED DESCRIPTION OF EMBODIMENTS

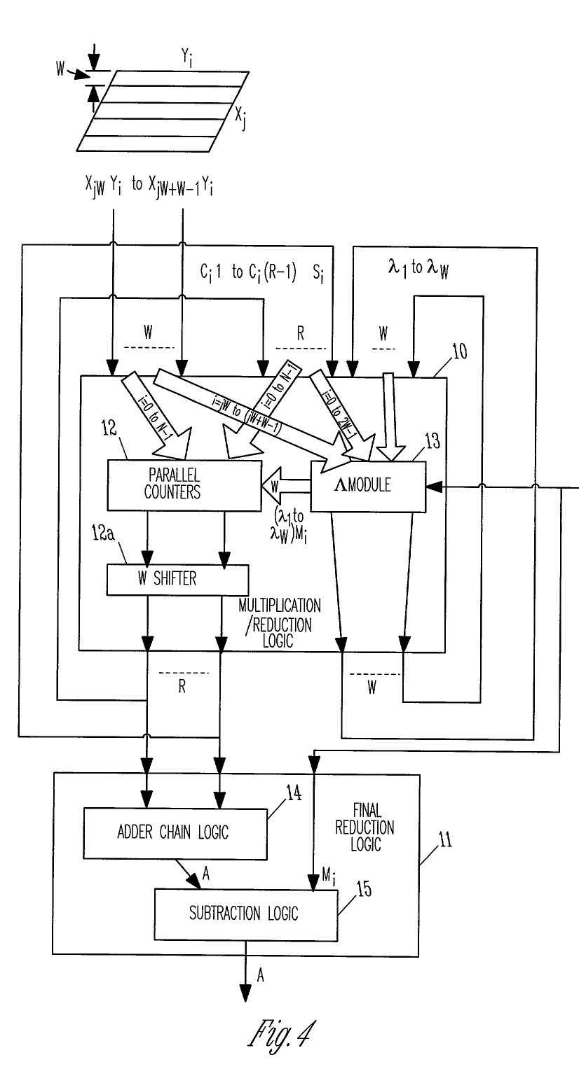

FIG. 4 is a schematic diagram showing the logic functions performed in a generalized embodiment of the present invention. The logic circuit comprises two functional parts: the multiplication/reduction logic 10 and the final reduction logic 11. The multiplication/reduction logic receives as inputs W multi-bit binary numbers X_{jW}Yᵢ to X_{(jW+W-1)}Yi. These are the parallel inputs representing W rows of the array. The input of W rows of the array represents a parallelization of the Montgomery multiplication process. Also input to the multiplication/reduction logic 10 are the feedback outputs of the multiplication/reduction logic 10 comprising R inputs, Cᵢ1 to Cᵢ(R−1) and S_{y}. The third set of inputs (a set of W inputs) comprise the feedback Λ values λ₁ to λ_{W}. Another input to the multiplication/reduction logic 10 is the modulus Mᵢ comprising a N bit binary value.

Within the multiplication/reduction logic 10, parallel counters 12 are provided as an array of parallel counters for combining multi-bit binary numbers to generate a plurality R of multi-bit binary output values. Each cycle the accumulated values are fed back, after shifting to the left by W bits (equivalent to division by 2^{W}) by the W shifter 12a, as inputs to the multiplication/reduction logic 10. The inputs to the parallel counters 12 comprise the bits 0 to N−1 of the multi-bit combination values X_{jW}Yᵢ to X_{(jW+W-1)}Yᵢ, the bits 0 to N−1 are the R feedback multi-bit binary values Cᵢ1 to Cᵢ(R−1) and Sᵢ, and the W multi-bit values generated by the Λ module 13 in the multiplication/reduction logic 10. The W multi-bit values are generated by the Λ module 13 by multiplying Λ by Mᵢ. This generates an array of W multi-bit values.

The Λ module 13 receives as inputs the W bits of Λ(λ₁ to λ_{W}), the 2W least significant bits of the W multi-bit input values and the R feedback values. The Λ module 13 uses these inputs to generate the W multi-bit values for input to the paragraph counters 12 and to generate A for feedback as an input for the next cycle j.

Thus the multiplication/reduction logic 13 performs the logic operations for j cycles until all of the array XⱼYᵢ has been input, i.e. for j cycles where j=N/W, where N is the number of bits of the input X. When all of the inputs have been processed, the resultant accumulated value comprises R multi-bit values which are input to the final reduction logic 11. Within the final reduction logic 11 there is an array of adders in adder chain logic 14 which receive the plurality R of multi-bit binary values and adds them to generate an intermediate multi-bit binary value A. Also input to the final reduction logic 11 is the multi-bit binary modulus value Mᵢ. The final reduction logic 11 includes subtraction logic 15 which operates to compare the intermediate multi-bit binary value A with the modulus Mᵢ and to subtract Mᵢ from the intermediate multi-bit binary value A if the intermediate multi-bit binary value A is not less than the multi-bit binary modulus value. Thus the output A of the subtraction logic 15 is the Montgomery product.

The method is based on pre-computing several new rows of the reduction array at each cycle of computation. As a result, a larger part of multiplication-reduction array is reduced at the next cycle using fast parallel counters.

At each cycle of MP computation, W rows of the multiplication array and W rows of the reduction array generated at the previous cycle are reduced to R rows using a parallel counter of the size 2^{R}−x, where 2^{R-1}≦x<2^{R}, and x can be determined from the formula

2^{R}−x=R+2W

One MP is then computed in N/W cycles. Note that the required number of cycles per MP is inversely proportional to W, while the time delay of a cycle grows only as log (W), due to the property of parallel counters used in the design such as those disclosed in co-pending application GB 0019287.2, GB 010961.1, U.S. Ser. No. 09/637,532, U.S. Ser. No. 09/759,954, U.S. Ser. No. 09/917,257, PCT/GB01/03415 and PCT/GB01/04455 the content of which is hereby incorporated by reference.

Montgomery Multiplier consists of N processing elements connected in linear chain and a logic block, which performs a pre-computation of a W-bit number Λ, which is used to generate W-rows Λm of the reduction array at the next cycle. Each processing element consists of a parallel counter and a number of flip-flops containing the intermediate result of a computation. The chain of processing elements is reused cycle after cycle of a computation in a sequential manner, while the reduction of the multiplication-reduction array within each cycle is performed in parallel.

Given the number of cycles one can spend per Mp (without the final reduction), the size of the counters which should be used to the design the appropriate Montgomery Multiplier can be determined from the following table:

| | | The number of | | |
|---|---|---|---|---|
| | | pre-computed | Parallel | Parallel |
| Number of | Number of | rows of the | counter | counter's |
| cycles (N/W), | cycles (N/W), | reduction array | size | redundancy |
| N = 1024 bit | N = 512 bit | (W) | (Cᵣ) | (R) |
| 512 | 256 | 2 | 7 | 3 |
| 342 | 171 | 3 | 10 | 4 |
| 256 | 128 | 4 | 12 | 4 |
| 205 | 103 | 5 | 14 | 4 |
| 128 | 64 | 8 | 21 | 5 |
| 79 | 40 | 13 | 31 | 5 |
| 64 | 32 | 16 | 38 | 6 |
| 37 | 19 | 28 | 62 | 6 |
| 32 | 16 | 32 | 71 | 7 |
| 18 | 9 | 60 | 127 | 7 |
| 16 | 8 | 64 | 136 | 8 |

The number of flip-flops per processing element is equal to the redundancy of the counter plus one (to store one of the multiplication factors).

The algorithms for performing the function illustrated in FIG. 4 can be divided into two main classes according to whether a certain pre-computation with a given modulus should be performed prior to Montgomery Multiplication or not. The first class are based on pre-computing two and three rows of the reduction array correspondingly and use 7 to 3 and 10 to 4 parallel counters. The pre-computation for Λ generation during Montgomery multiplication is relatively easy and can be performed one cycle in advance, so no additional pre-computations are needed.

The second class comprises algorithms with W≧4. The complexity of pre-computation of W rows of the reduction array grows fast with W. For W≧4 it can be performed in time of a main cycle at the expense of a single pre-computation per modulus, the cost of which is negligible compared to the cost of a single modular exponentiation.

The general algorithm illustrated functionally in FIG. 4 can be expressed in pseudo code as follows:

Input: m=(m_{N-1} . . . m_{w}1 . . . 1) (binary representation)

x=(x_{N-1} . . . x₁x₀) (binary representation)

y=(y_{N-1} . . . y₁y₀) (binary representation)

R=2^{N}

0≦x,y<m,N=Wk

Output: MP(x,y)=xyR⁻¹ mod m

1) A←0 (A=(a_{N} . . . a₁a₀))

3) Cycle: j=0, . . . , k:

2.1 A←(A+x_{wj}y+2x_{wj+1}y+ . . . +2^{w-1}x_{wj+w-1}y)

2.2 Λ=A|mod 2^{w}

2.3 A←(A+Λm)/2^{w}

4) If A>m, A←A−m.

5) Return A.

It can be seen from the pseudo code given hereinabove that the total number of cycles using the algorithm in accordance with this embodiment of the present invention is N/W. At each cycle W multi-bit binary combinations are input and added to the current accumulator values (i.e. the R feedback values). Also the A values are determined as values which set the W bits of the accumulator to 0, i.e:

Λ=A|mod2^{W}.

Λ is then multiplied by the modulus N and added into the accumulator. The accumulator values are then shifted to the right by W bits, i.e. the accumulator value is divided by 2^{W} (step 2.3).

The final reduction logic 11 forms the aggregation of the outputs of the parallel counters 12 (in the adder chain logic 14) and step 4 in the algorithm given above.

A specific embodiment of the present invention will now be described for W=2. This embodiment employs 7 to 3 counters and pre-computes λ one step in advance.

The reduction step of the prior art MP algorithm consists of finding a one-bit number λ such that A+λm is divisible by 2. At the next cycle of the algorithm the step of finding λ is repeated. Two cycles of the MP algorithm can be performed in parallel in a single cycle if one can find a two bit number Λ=(λ₂λ₁), such that A+Λm is divisible by 4. It is easy to verify that

λ₁=a₀; λ₂=a₀\hat{ } [symbol] m₁⊕a₁.

Standard notation is used for logical operators: \hat{ } represents a logical ‘and’, [symbol] represents a logical ‘or’, [symbol] represents a logical negation, and ⊕ represents a logical ‘exclusive or’. The division of A+Λm by 4 consists of a right shift by two places and

(A+Λm)/4=A2⁻²|mod m,

where 2⁻² is an integer which is modulo inverse of 4. The multiplication step in each cycle consists of adding two more rows of the multiplication array to the accumulator A. As a result the total number of cycles is equal to N/2, half the number of the cycles of the prior art MP algorithm.

The pseudo code for this algorithm (W=2) is:

Input: m=(m_{N-1} . . . m₁m₀) (binary representation)

x=(x_{N-1} . . . x₁x₀) (binary representation)

y=(y_{N-1} . . . y₁y₀) (binary representation)

R=2^{N}

0≦x,y<m, m is odd, m<R, N=2k.

Output: MP(x,y)=xyR⁻¹ mod m

1) A←0 (A=(a_{N} . . . a₁a₀))

2) Cycle: j=0, . . . , k−1:

2.1 A←(A+x₂ⱼy+2x₂ⱼ₊₁y)

2.2 λ₁=a₀; λ₂=a₀\hat{ } [symbol] m₁⊕a₁

2.3 A←(A+(2λ₂+λ₁)m)/4

3) If A≧m then A←A−m

4) Return A

The implementation of this algorithm will now be described in more detail.

As in the prior art implementations, the intermediate result is kept in redundant form, now as a sum of three N bit numbers: S=(S_{N-1}S_{N-2} . . . S₀), C=(C_{N-1}C_{N-2} . . . C₀) and D=(D_{N-1}D_{N-2} . . . D₀). The array, which has to be reduced at each cycle of the MP4 algorithm, looks as follows:

| | | | | | | | | |
|---|---|---|---|---|---|---|---|---|
| 0 | 0 | S_{N} | S_{N-1} | | S₃ | S₂ | S₁ | S₀ |
| 0 | 0 | C_{N} | C_{N-1} | | C₃ | C₂ | C₁ | C₀ |
| 0 | 0 | D_{N} | D_{N-1} | | D₃ | D₂ | D₁ | D₀ |
| 0 | 0 | 0 | λ₁m_{N-1} | . | λ₁m₃ | λ₁m₂ | λ₁m₁ | λ₁ |
| 0 | 0 | λ₂m_{N-1} | λ₂m_{N-2} | . | λ₂m₂ | λ₂m₁ | λ₂ | 0 |
| 0 | x₂ⱼy_{N-1} | x₂ⱼy_{N-2} | x₂ⱼy_{N-3} | . | x₂ⱼy₁ | x₂ⱼy₀ | 0 | 0 |
| x₂ⱼ₊₁y_{N-1} | x₂ⱼ₊₁y_{N-2} | x₂ⱼ₊₁y_{N-3} | x₂ⱼ₊₁y_{N-4} | | x₂ⱼ₊₁y₀ | 0 | 0 | 0 |
| | | | | | | | | + |
| S′_{N} | S′_{N-1} | S′_{N-2} | S′_{N-3} | . | S′₁ | S′₀ | 0 | 0 |
| C′_{N} | C′_{N-1} | C′_{N-2} | C′_{N-3} | . | C′₁ | C′₀ | 0 | 0 |
| D′_{N} | D′_{N-1} | D′_{N-2} | D′_{N-3} | . | D′₁ | D′₀ | 0 | 0 |

For the purpose of convenience the updated values of the accumulator are denoted using primed symbols. The updated values of the accumulator result from the 7 to 3 reduction by a parallel counter with the exception of S′_{N}=x₂ᵢy_{N-1} and D′₀=S₀ [symbol] C₀ [symbol] D₀. The latter expression is not obvious and has to be verified using the following explicit expressions for lambdas:

λ₁=S₀⊕C₀⊕D₀

λ₂=S₁⊕C₁⊕D₁⊕λ₁m₁⊕C⁽¹⁾,

where C⁽¹⁾ is the first carry resulting from the summation of four numbers in the 0-th array:

C⁽¹⁾=(S₀ [symbol] C₀ [symbol] D₀)\hat{ } [symbol] (S₀\hat{ }C₀\hat{ }D₀)

At each cycle of the implementation, each processing element will reduce one column of 7 values to 3 values using a 7 to 3 counter. At the start of each cycle, the appropriate λ₁ and λ₂ need to be available in each processing element before the reduction can start. Calculating λ₁ and λ₂ according to the above equations would therefore generate a delay in each cycle, equal to the time needed to calculated the values of λ₁ and λ₂, plus the time needed to distribute them over all processing elements via buffer trees. To avoid this delay, the values of λ₁ and λ₂ are pre-computed one cycle in advance.

Let λ′₁ and λ′₂ to denote the lambdas for the next cycle. Pre-computation of λ₁ and λ₂ can thus be seen as computation of λ′₁ and λ′₂ during the current cycle. λ′₁ can be expressed as:

λ′₁=a′₀

λ′₂=λ′₁\hat{ } [symbol] m₁⊕a′_{1,}

where

a′₀=S′₀⊕C′₀⊕D′₀

and

a′₁=S′₁⊕C′₁⊕D′₁⊕(S′₀\hat{ }C′₀ [symbol] S′₀\hat{ }D′₀ [symbol] C′₀\hat{ }D′₀).

The primed bits on the right hand side can be obtained using parallel counters as follows:

D′₀=S₀ [symbol] C₀ [symbol] D₀

(D′₁, C′₀, 0)=Counter 53(S₁, C₁, D₁, λ₁m₁, λ₂)

(●, C′₁, S′₀)=counter 63(S₂, C₂, D₂, λ₁m₂, λ₂m₁, x₂ⱼy₀)

(●, ●, S′₁)=Counter 73(S₃, C₃, D₃, λ₁m₃, λ₂m₂, x₂ⱼy₁, x₂ⱼ₊₁y₀),

where ‘●’ denotes a ‘don't care’. In the implementation, modified counters can be used that produce only the required output bits.

The pre-computation of the lambdas must be fast enough to fit in one cycle of a standard processing element. Otherwise, all N processing elements will be idling, waiting for the pre-computation to finish, which makes the suggested computational scheme inefficient. Fortunately, λ′₁ and λ′₂ can be computed within the standard clock cycle by:

i) Computing the lambdas in a special processing element, which is connected directly to the flipflops, thus bypassing the buffer trees.

ii) By using high-speed logic gates for this special processing element. Note that the area/cost for this special processing element is negligible compared with that of the whole implementation, since the number (N) of standard processing elements is of the order of a thousand.

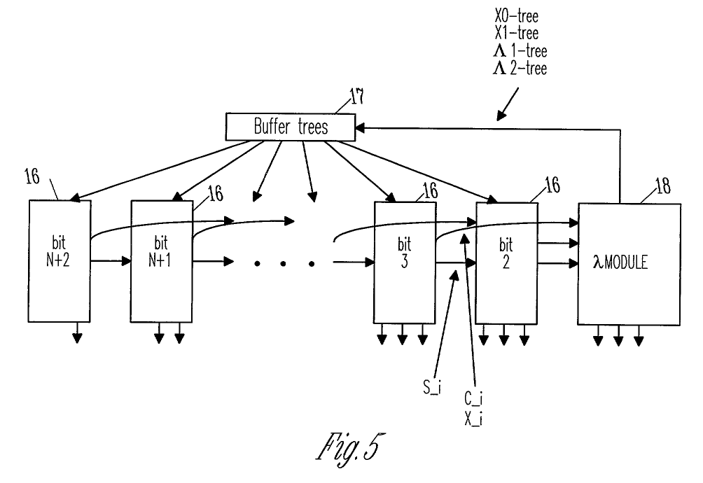

FIG. 5 shows the overall layout the implementation for W=4. It consists of N identical processing elements 16, for bits 2 to N+2, and a special processing element 18, for the 2 rightmost columns of the array and the computation of λ′₁ and λ′₂.

Each processing element 16 is connected to the 2 processing elements 16 on its right, and to the 0-th processing element 16 via four buffer trees 17. Two trees, Λ₁-tree and Λ₂-tree, distribute λ₁ and λ₂. The X₀-tree and X₁-tree distribute x₂ⱼ and x₂ⱼ₊₁, respectively.

The structure of each processing element 16 and their interactions will first be discussed. Then the flow of data through the implementation as it computes the MP(x,y) will be discussed.

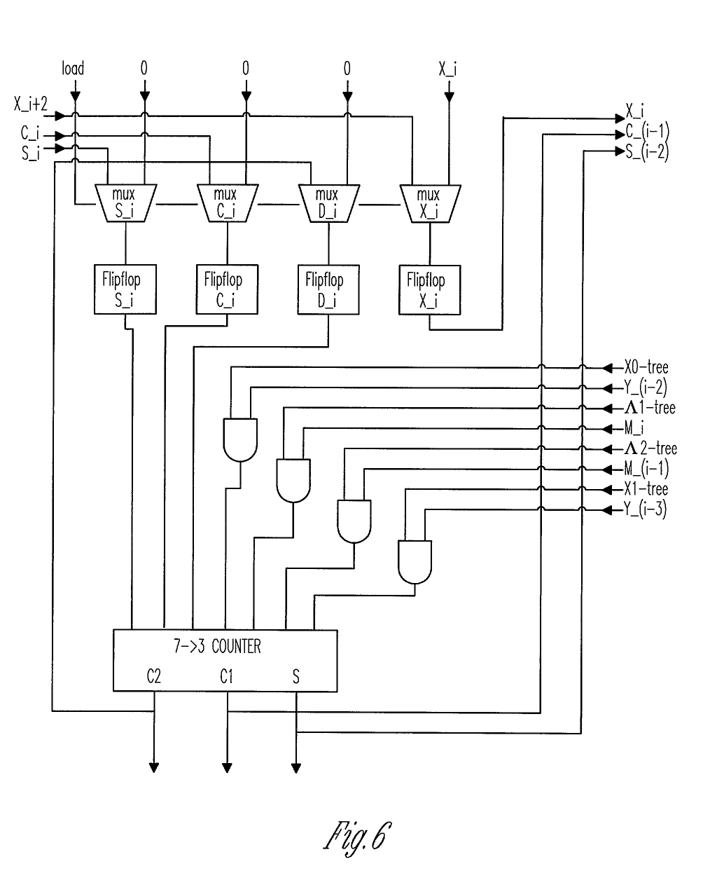

FIG. 6 shows the logical structure of a processing element. It contains four flipflops. Three flipflops (S, C and D) of the i-th processing element 16 store Sᵢ, Cᵢ and Dᵢ, the i-th bits of the redundant intermediate result. The fourth flipflop of the i-th processing element 16 contains xᵢ₊₂ⱼ, at the j-th cycle, where by definition the value of xₖ is 0 for k≧N. Each flipflop can be initiated, as in the prior art implementation, using the multiplexers. Each processing element 16 also contains four AND gates, that compute λ₁mᵢ, λ₂mᵢ₋₁, x₂ⱼyᵢ₋₂ and x₂ⱼ₊ⱼyᵢ₋₃. Each processing element 16 also contains one 7 to 3 counter, which reduces Sᵢ+Cᵢ+Dᵢλ₁mᵢ₋₁+x₂ⱼyᵢ₋₃ to Sᵢ₋₂+2Cᵢ₋₁+4Dᵢ.

The i-th processing element 16 feeds its output Xᵢ into the (i−2)-th processing element 16, and therefore receives its input Xᵢ₊₂ from the (i+2)-th processing element 16. This ensures that the special processing element 18 contains x₂ⱼ and x₂ⱼ₊₁ in flipflops X₀ and X₁ at the start of the j-th cycle of the algorithm. The i-th processing element 16 feeds its output Sᵢ₋₂ into the (i−2)-th processing element 16, and therefore receives its input Sᵢ from the (i+2)-th processing element 16. The i-th processing element 16 feeds its output Cᵢ₋₁ into the (i−1)-th processing element 16. The second carry Dᵢ feeds back into the D flipflop of the same processing element 16. These tree feedbacks correspond to the 2 bit right shift (division by 4) in the algorithm. The inputs yᵢ₋₂yᵢ₋₃, mᵢ and mᵢ₋₁ of i-th processing element 16 are connected to the corresponding registers storing y and m. The X0, X1, Λ1 and Λ2 inputs of the i-th processing element 16 are connected to X0-, X1-, Λ1- and A2-buffer trees, respectively. The initial values of the S, C, D and X flipflops are 0, 0, 0 and xᵢ, respectively.

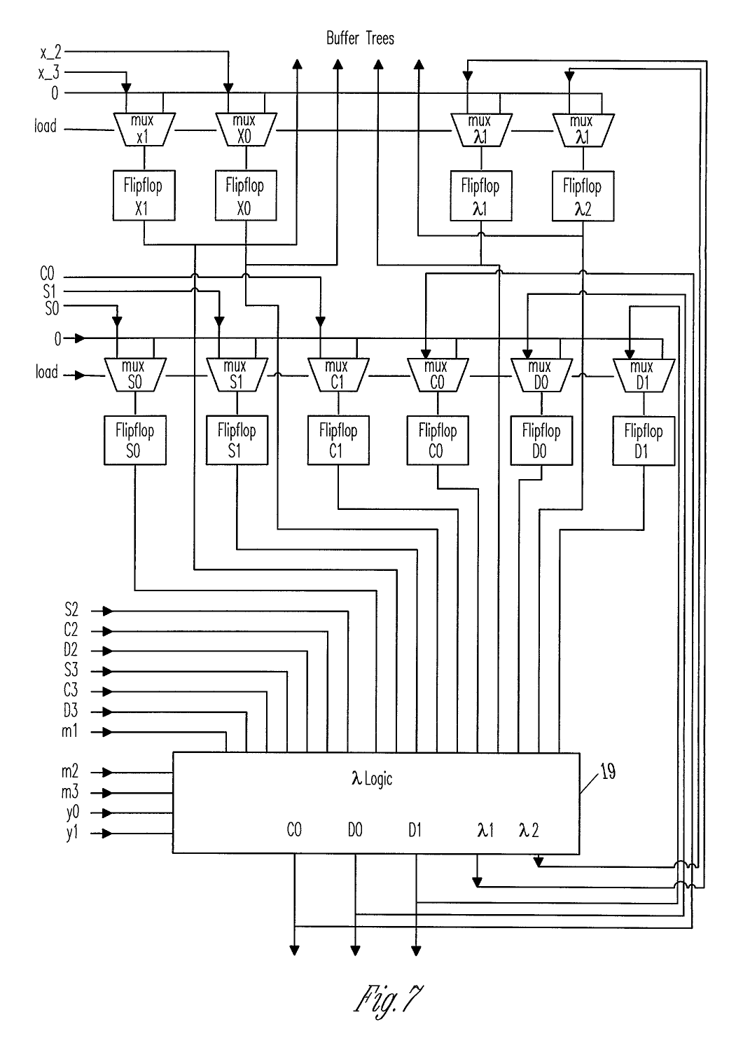

The structure of the special processing element 18 for bits 0 and 1 and the pre-computation of lambdas is shown in FIG. 7. It contains ten flipflops which store X₀, X₁, λ₁, λ₂, S₀, S₁, C₀, C₁, D₀, D₁ respectively. It also contains a logic block 19, which performs the computation of λ′₁, λ′₂. This special processing element 18 receives its inputs from the y- and m-registers and from 2^{nd} and 3^{rd} processing elements 16, and feeds its outputs into the four X- and Λ-trees as shown on FIG. 7.

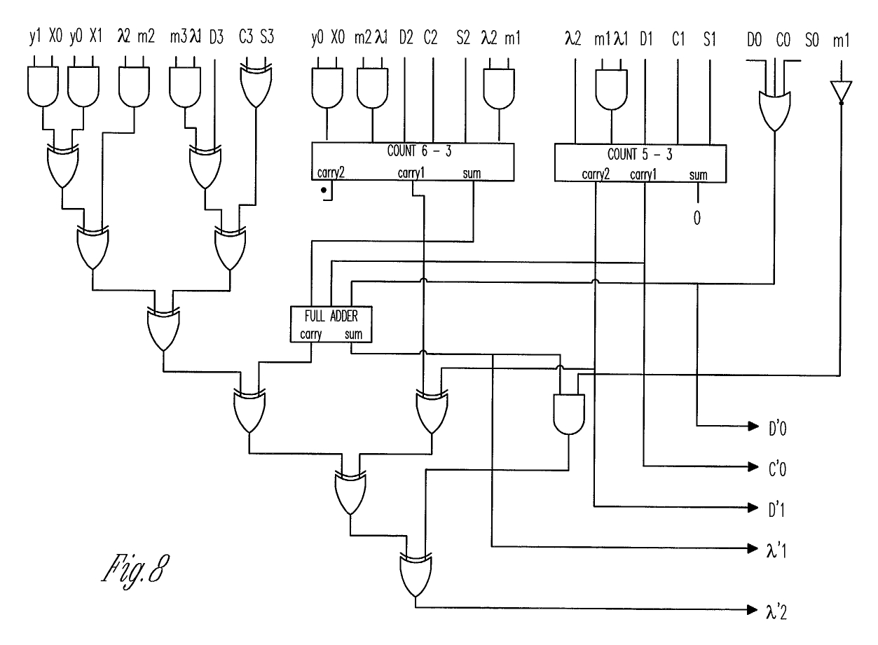

The structure of the logic block 19 is shown in FIG. 8. The presented structure is a direct implementation of the formulae for the computation of λ′₁, λ′₂ given hereinabove. The implementation can be optimised if necessary. Possible optimisations are not shown here. The logic block also computes bits C₀, D₁ and D₀ of the intermediate answer which are fed back into the flipflops of the special processing element 18.

The flow of data for the computation of one MP is as follows. Before the first cycle starts, the initial values are loaded into the flipflops, by means of the multiplexers. At each cycle the xᵢ's shift two positions to the right, such that the X₀ and X₁ flipflops of the special processing element 18 contain x₂ⱼ and x₂ⱼ₊₁ respectively at the start of the j-th cycle. In the process of the cycle x₂ⱼ and x₂ⱼ₊₁ are delivered to all processing elements 16 via the X0- and X1-buffer trees. The 7 to 3 counter then reduces Sᵢ+Cᵢ+Dᵢ+λ₁mᵢ+λ₂mᵢ₋₁+x₂ⱼyᵢ₋₂+x₂ⱼ₊₁yᵢ₋₃ is reduced to Sᵢ₋₂+2Cᵢ₋₁+4Dᵢ. The second carry Dᵢ is fed into the D flipflop of the i-th processing element 16, the carry Cᵢ is fed into the C flipflop of the (i−1)-th processing element 16 and the sum Sᵢ is fed into the S flipflop of the (i−2)-th processing element 16, thus incorporating the division by 4. The special processing element 18 is connected directly to relevant flipflops thus bypassing the buffer tree 17. It pre-computes λ₁ and λ₂ for the next cycle within a delay of a buffer tree 17 and a generic processing element 16. After the N-th cycle, the outputs S, C and D must be added and the final reduction (step 3 of the algorithm) has to be performed.

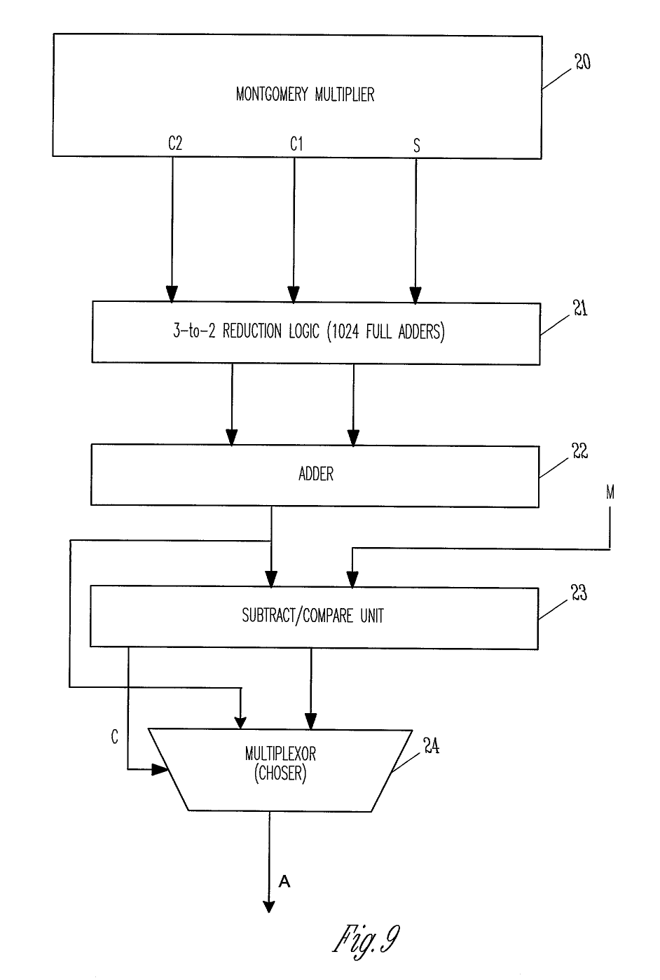

FIG. 9 is a schematic functional diagram of the logic for performing the complete Montgomery multiplication process. The Montgomery multiplier 20 comprises the logic as illustrated in FIG. 5 and generates three multi-bit binary outputs C2, C1 and S. These are input into 3 to 2 reduction logic 21 which comprise 1024 full adders. The result is two multi-bit binary numbers which are input to an adder 22 to generate a single multi-bit binary number. This number is input to a subtract/compare unit 23 together with the modulus M. The subtract/compare unit 23 compares the output of the adder 22 with M and two outputs are input to a multiplexer 24. One of the outputs comprises a carry C used as the selector for the multiplexer 24. The output of the adder 22 is also input to the multiplexer 24. Thus if the result of the subtraction in unit 23 is negative, the multiplexer 24 is switched to output the output of the adder 22 (in other words the output of the adder 22 is <M) and if the output of the subtract/compare unit 23 is not negative, the multiplexer 24 is controlled to output as the output A the output of the subtract/compare unit 23 (in other words the output of the adder 22 was ≧M and thus the output is the output of the adder 22 minus M. Thus the subtract/compare unit 23 and the multiplexer 24 perform step 3 of the algorithm.

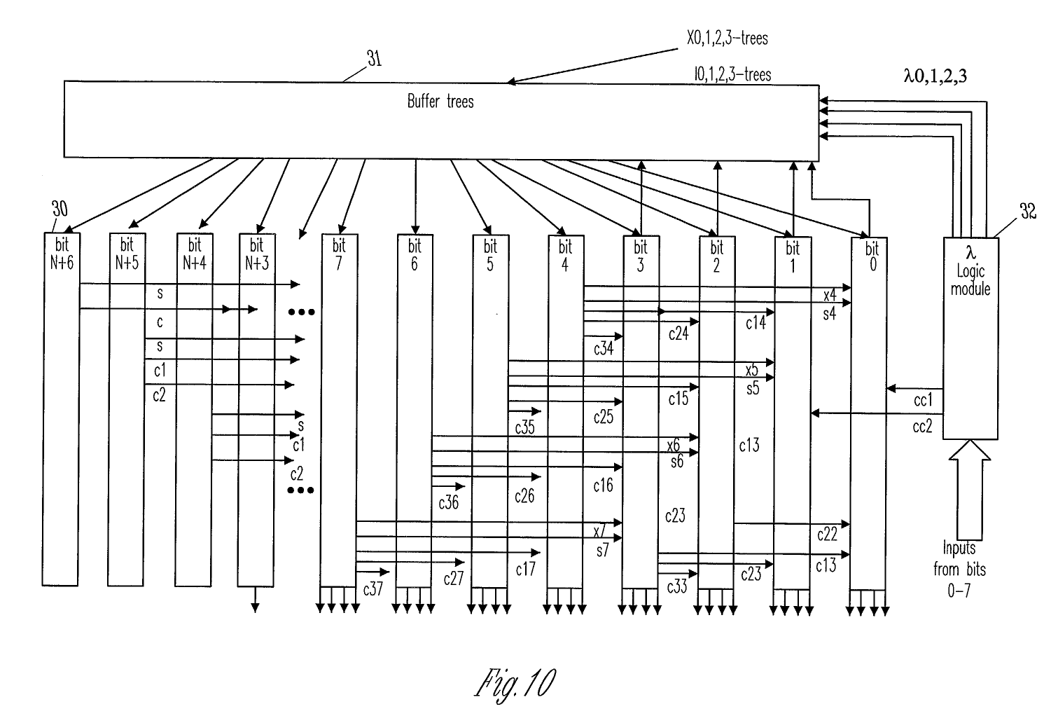

A second embodiment of the present invention will now be described with reference to FIGS. 10 to 14. This embodiment of the present invention comprises an implementation for W=4, i.e. four rows of the array are input in parallel and four λ values are generated in each cycle.

The design uses 12 to 4 parallel counters such as those described in co-pending applications GB 0019287.2, GB 0101961.1, U.S. Ser. No. 09/637,532, U.S. Ser. No. 09/759,954, U.S. Ser. No. 09/917.257, PCT/GB01/03415 and PCT/GB01/04451, the contents of which are hereby incorporated by reference. The design is approximately twice as fast compared to the previous implementation for W=2 and is approximately twice as large. The design description closely follows the description of the previous implementation.

FIG. 10 is a diagram illustrating the Montgomery multiplier logic and comprises a plurality of processing elements 30 each receiving corresponding bits of the inputs from buffer trees 31. A lambda logic module 32 is provided for the computation of Λ (i.e. the four λ values denoted by λ₀, λ₁, λ₂ and λ₃ in this embodiment).

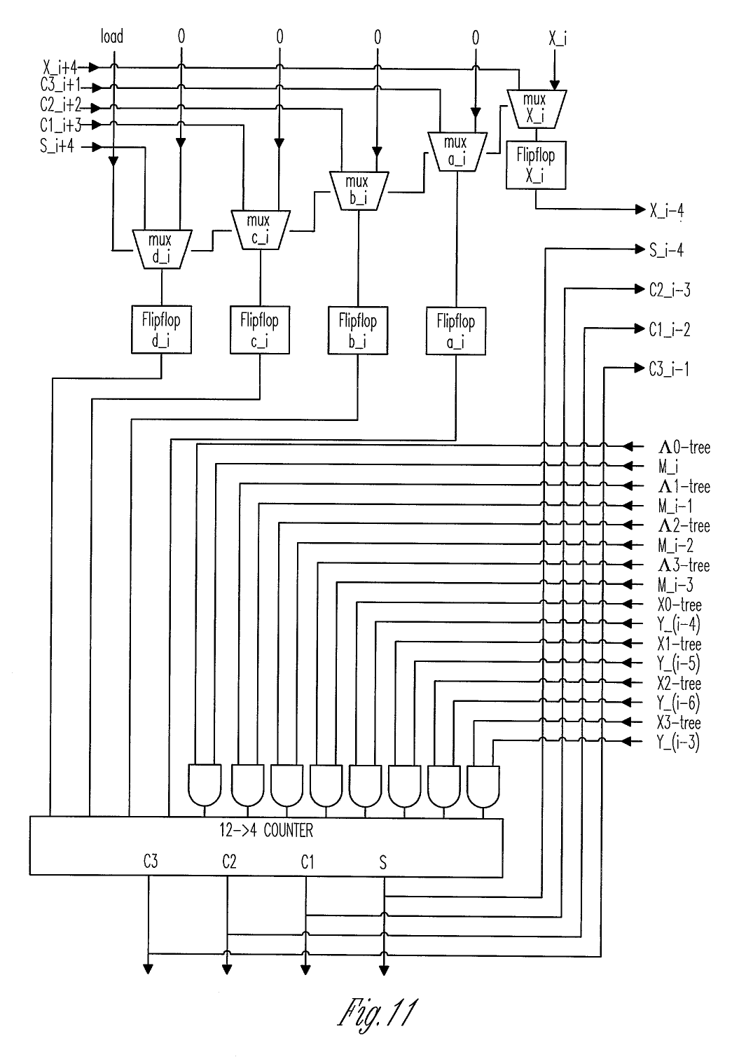

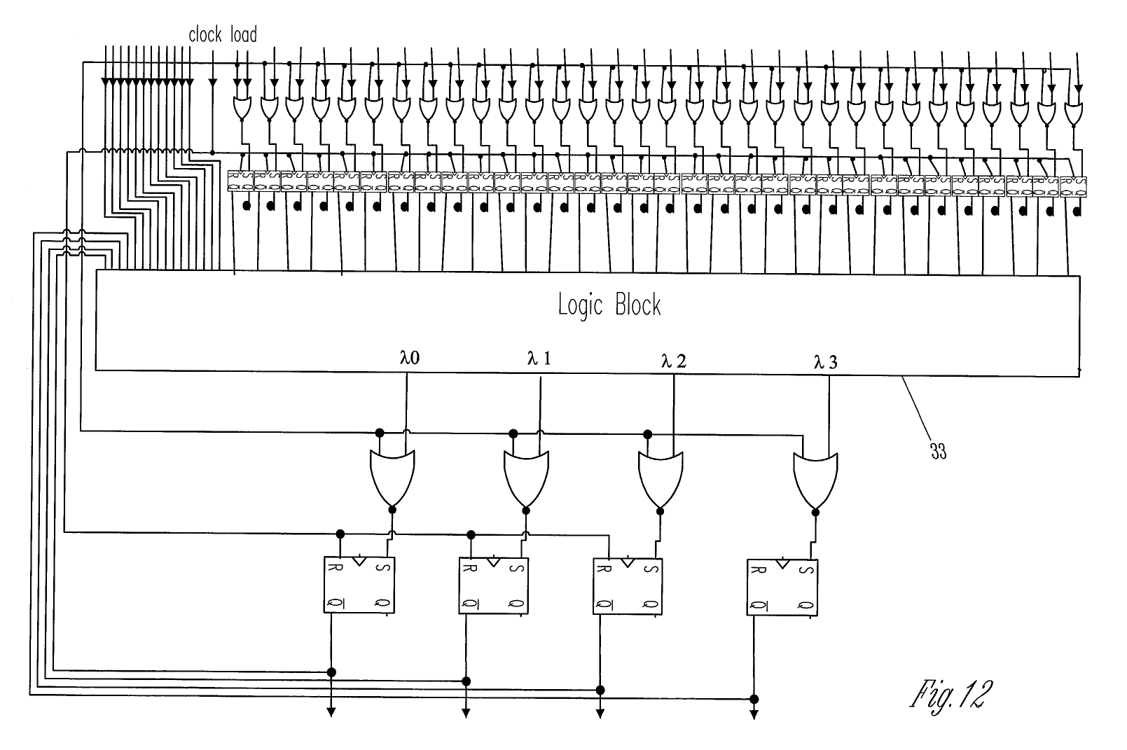

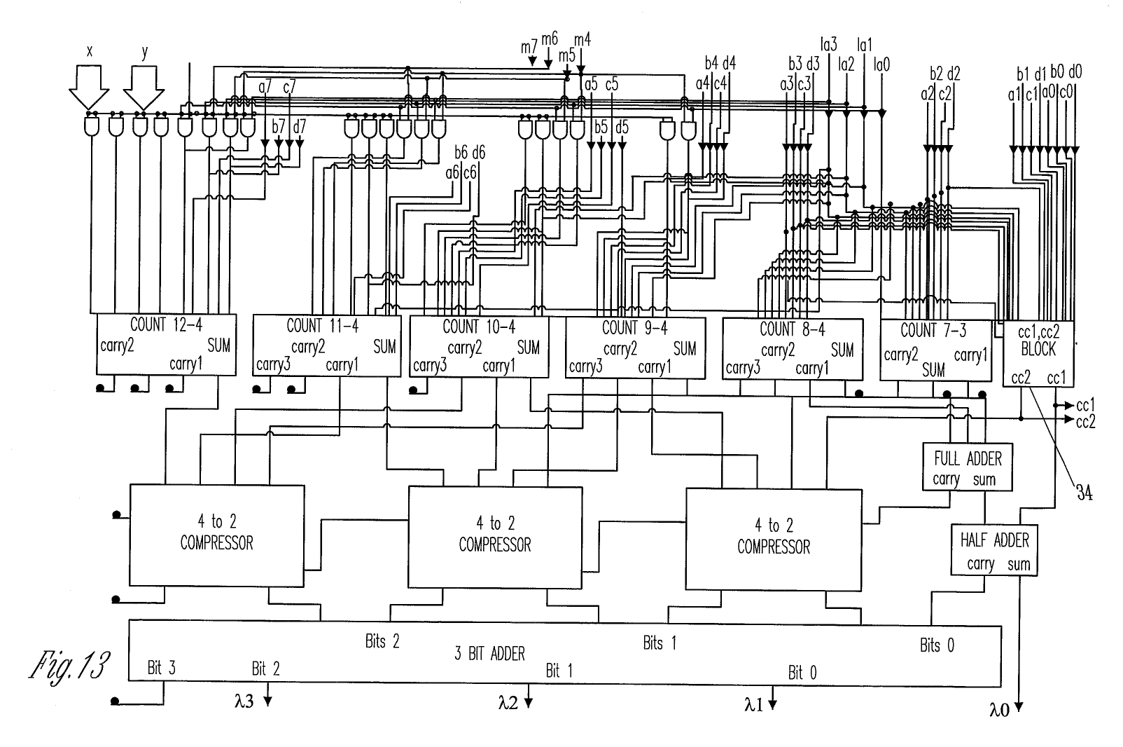

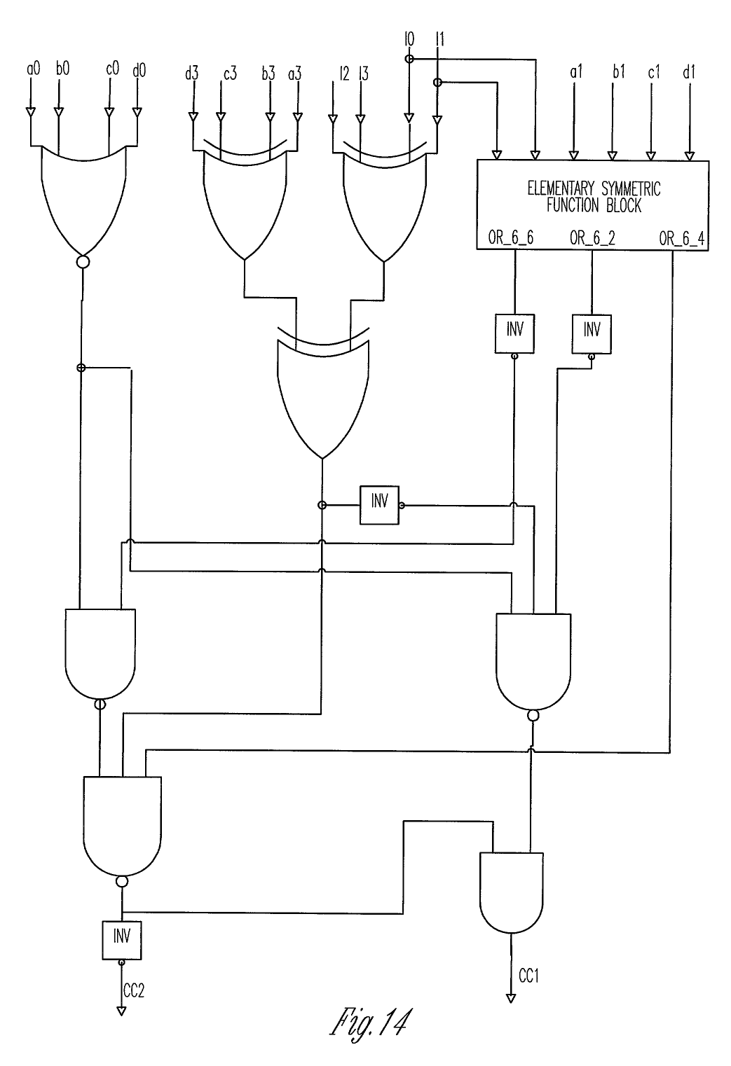

FIG. 11 is a diagram of the logic contained in a processing element 30. FIG. 12 is a diagram of the Λ logic module 32. FIG. 13 is a diagram of the logic contained in the logic block 33 in the Λ logic module illustrated in FIG. 12. FIG. 14 is a diagram of the logic contained in the CC1, CC2 block 34 in the logic unit of FIG. 13. The design description of this embodiment of the present invention closely follows the description of the previous implementation.

The present invention encompasses the parallel input of any number of rows of the array, i.e. W can be any value >2. For example, when W=3, the algorithm is based on the pre-computation of a three-bit number Λ=(λ₃λ₂λ₁) such that A+Λm is divisible by 8. The expressions for λ's in terms of the modulus and the number in the accumulator is

λ₁=a₀; λ₂=a₀\hat{ } [symbol] m₁⊕a₁, λ₃=a₂⊕(a₀\hat{ } [symbol] m₂+ [symbol] a₀\hat{ }a₁\hat{ } [symbol] m₁).

So far, embodiments of the present invention have been described in which the modular multiplication of two input multi-bit binary numbers is achieved by a logic circuit implementing an algorithm in accordance with the present invention.

The modular multiplication technique can however be utilized in modular exponentiation to provide an improved modular exponentiation algorithm executed by a logic circuit.

It is known in the prior art that Montgomery multipliers can be used for modular exponentiation. The technique for example is disclosed as one of the techniques in the article by Cetin Kaya Koc entitled “RSA Hardware Implementation” (RSA Laboratories, RSA Data Security Inc) available at ftp://ftp.rsasecurity.com/pub/pdfs/tr801.pdf. Since the Montgomery multiplier of embodiments of the present invention does not require any additional inputs compared to the prior art Montgomery multipliers, it is possible to use conventional prior art exponentiation techniques employing a Montgomery multiplier in accordance with the present invention.

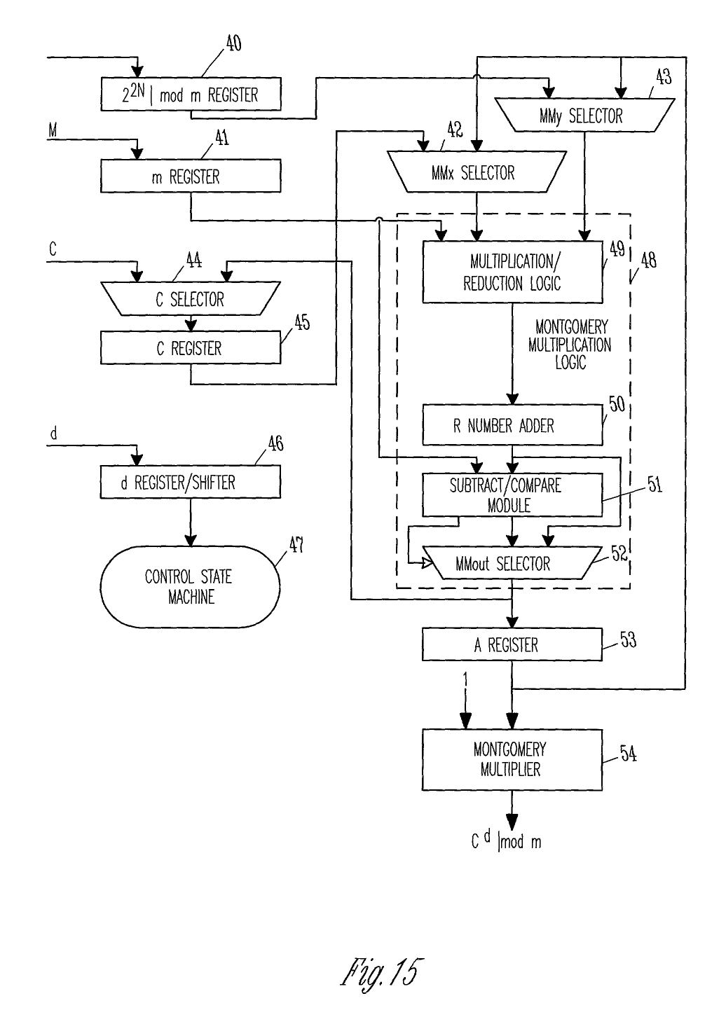

The process of exponentiation using the Montgomery multiplier will now be described with reference to FIG. 15.

In an initial pre-computation step, whenever the modular m is changed, it is necessary to compute 2^{2N}|mod m.

Even though in most applications this step is performed on the level of software, how carry it out using a hardware which is an integral part of any modular exponentiator based on a Montgomery Multiplier will now be explained.

2^{2N}|mod m can be computed using a version of Blakely's algorithm: Firstly, note that

2^{N}|mod m=2^{N}−m.

(We always assume that m_{N-1}=1, therefore m>2^{N}−m>0.) In fact, 2^{2N}|mod m can be written in a closed form due to the fact that m is odd:

2^{N}|mod m= [symbol] m_{N-2} [symbol] m_{N-3} . . . [symbol] m₁1.

2^{2N}|mod m can now be computed via the following algorithm:

Modified Blakeley Algorithm.

1. Acc=2^{N}−m;

2. For i=1 to N:

2.1. Acc←2·Acc;

2.2. If Acc>m, then Acc←Acc−m;

3. Output 2^{2N}|mod m=Acc.

Note that the described pre-computation can be easily carried out using the add-subtract-compare unit, which is an integral part of any Montgomery Multiplier.

Each time a new string of data (an N-bit number) C arrives, a number C′=(C 2^{N)}|mod m should be computed. This is done using the Montgomery Multiplier itself, as C′=MP(C,2^{2N}|mod m).

The final answer, M=C^{d}|mod m, can now be computed via a version of left-to-right exponentiation algorithm adapted to the use of Montgomery multiplications:

Left-to-right exponentiation algorithm.

Input: C′, d−N-bit numbers;

Output: M;

1. Acc=1;

2. For i=N−1 to 0:

2.1. if dᵢ=1, Acc←NP(Acc, C′) and go to 2.2, else go to 2.2;

2.2. Acc←MP(Acc, Acc);

3. Output M=MP(Acc, 1).

Step 3 of the algorithm is correct due to a special property of Montgomery Multiplication: if for any integer A<m, A′ denotes (A2^{N})mod m, then MP(A′, B′)=(AB)′. From this it is easy to see that the final value of the accumulator before Step 3 is M′. But, M=MP(M′,1), which follows from the definition of Montgomery Product.

FIG. 15 is a diagram illustrating the logical implementation of the exponentiation algorithm. The register 40 stores the value 2^{2N}|mod m. The modulus m is input into the m register 41. The number to be exponentiated c is input into the c selector 44 to select whether or not to input it into the c register 45. The exponent d is input into a d register/shifter 46 for use by a control state machine 47 to control the execution of the exponentiation process by the logic circuit.

The first step of the process controlled by the control state machine 47 is to convert c to c′. This is achieved by controlling the MMy selector 43 to read the content of the register 40 into the Montgomery multiplication logic 48. The multiplication/reduction logic 49 generates R output multi-bit binary numbers which are added by the R number adder 50. A subtract/compare module 51 and a MMout selector 52 form the third step of the Montgomery multiplication algorithm to ensure that the output value is less than M as described hereinabove.

The process performed by the Montgomery multiplication logic 48 can be described by:

MP(c.2^{2N|}mod m)=c 2^{2N}2^{-N}|mod m=c2^{N}|mod m

The output is loaded by the selector 44 into the c register 45 for use thereinafter.

The exponentiation process can now proceed using c′. The control state machine 47 then uses the exponent d in the d register/shifter 46 to control the exponentiation process. The most significant bits of d are looked at until a high bit is found. Once found the MMx selector 42 selects to input the content of the A register 53 and the MMy selector 43 selects to input the content of the A register 53. In this way the content of the A register 53 is squared. The content of the MMx selector 42 can also be controlled to instead input a single c′ value from the e register 45. Thus the control state machine 47 can use the value of d stored in the d register/shifter 46 to perform exponentiation using c′. An example of the exponentiation process is described with reference to a specific binary number below.

If d=1011 in binary (i.e. 11 in decimal) in step 0 of the process, c′ is loaded into the A register 53 as described hereinabove. In step 1 since the most significant bit is 1, the MMx selector 42 and MMy selector 43 are controlled to square the content of the A register, the next bit of d is 0 and thus the selectors 42 and 43 are controlled to once again square the content of the A register 53. The third most significant bit is 1 and thus the MMx selector 42 is controlled to input c′ from the c register 45 and thus the A register 53 contains c′⁵ and the next bit is moved to causing the MMx selector 42 and the MMy selector 43 to be switched to cause the squaring of the content of the A register 53 such that it contains c′¹⁰. The least significant bit comprises a 1 and thus the MMx selector 42 is controlled to input the content of the c register 45 (i.e. c′) such that the content of the A register 53 comprises c′¹¹. This process is illustrated below:

| Step | Process |
|---|---|
| 0 | A = c |
| 1 | A ← A² = c² |
| 2 | c₂ = 0 [symbol] A ← A² = c⁴ |
| 3 | c₁ = 1 [symbol] A ← A.c = c⁵ |
| 4 | A ← A² = c¹⁰ |
| 5 | c₀ = 1 [symbol] A ← A.c = c¹¹ |

All of the multiplications given above are Montgomery multiplications and thus the end product in the A register 53 is not c^{d}|mod m but instead c^{d}2^{N}|mod m (i.e. c′^{d}2^{-d(N-1)}|mod m). To convert the output to e, it is input into a Montgomery multiplier 54 (comprising the same Montgomery multiplication logic as in the Montgomery multiplication logic 48, and in fact it can comprise the same logic) together with a 1 as the other input. The result is thus:

c^{d}2^{N}2^{-N}|mod m=c^{d}|mod m

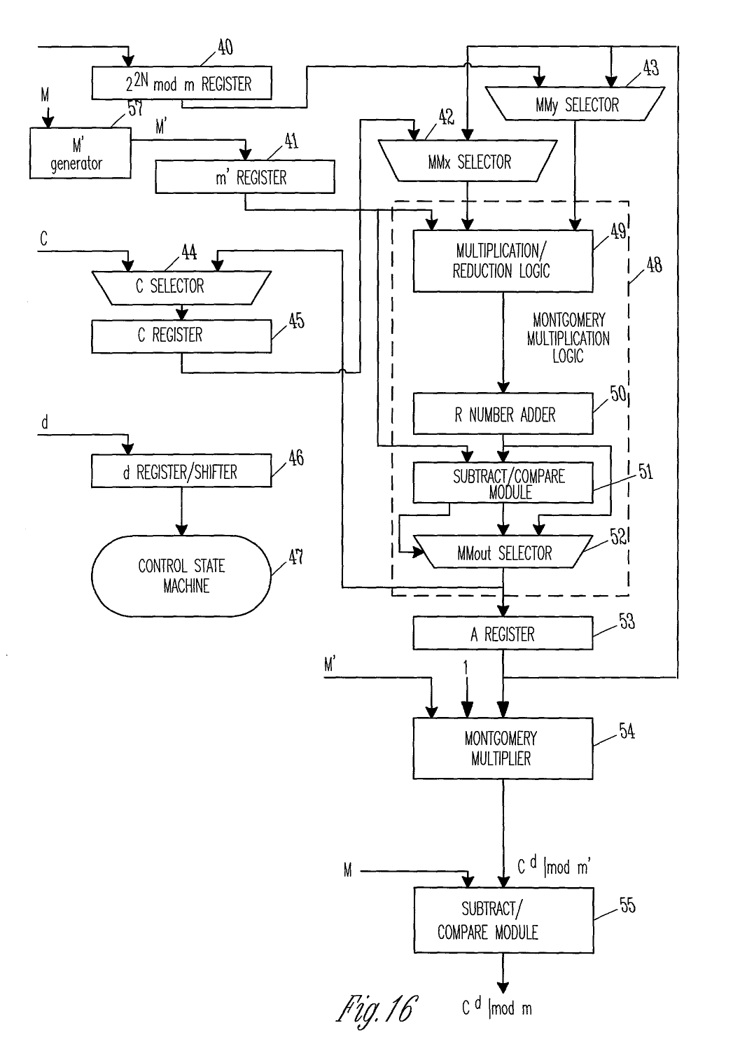

When computing the modular exponentiation using the Montgomery multiplication logic in accordance with the present invention, when W is large, the Λ logic unit becomes large and complex and can be a limiting factor in the speed of operation of the Montgomery multiplier. One method of speeding up operation of the Montgomery multiplier for large W is to modify the modulus from m to m′ by multiplying modulus m by factor x in order to make the last W bits all equal to 1 s. FIG. 16 illustrates the exponentiation logic in accordance with this embodiment of the invention. m is input into an m′ generator 57 and the new modulus m′ is used in the exponentiation process as described with reference to FIG. 15 to generate the output c^{d}|mod m′ from the Montgomery multiplier 54. In order to generate the output c^{d}|mod m, a subtract/compare module 55 is provided to subtract the original modulus m repeatedly until the output is less than m. In order to modify m to generate m′ within the generator 57, m is multiplied by a factor x which is a number from 0 to 2^{W}−1. Therefore, in order to remove the effect in the subtract/compare module 55, m is subtracted up to 2^{W}−1 times.

The setting of the W least significant bits of the modulus to 1 s simplifies the computation of Λ because in the computation the W least significant bits used for the computation of Λ can be ignored since they are known to be set to 1 s. For example, in the embodiments described hereinabove for W=2 the value m₁, m₂ and m₃ appear in the determination of the values for Λ (i.e. for λ₁ and λ₂). If these values were set to 1, these factors need not be considered in the determination of Λ: only the previous values for Λ, the accumulator values and the input W multi-bit binary combination values need be considered in the determination of Λ. However, since the pre-processing performed by the m′ generator 57 and the post-processing provided by the subtract/compare module 55 incur processing overheads, the benefit of using m′ in the exponentiation process is only realized for large Ws when there are a large number of Λ values. In practice the inventors have determined when W is greater than 4 there is an advantage in using m′ as the modulus during the exponentiation process.

Although in the embodiment described hereinabove, the conversion of the output from mod m′ to mod m is performed using a subtract/compare module 55, it is also possible to perform the same function by using a Montgomery multiplier having the output of the A register 53 as an input, 1 as a second input and the modulus input of m rather than m′. This generates C^{d}|mod m as the output.

Thus the present invention encompasses any method of performing an equivalent function to the subtraction of m from the output up to 2^{W-1} times in order to convert from mod m′ to mod m.

The process performed by the m′ generator 57 will now be described.

The objective of the computation is to find a (W+N)-bit number m′ such that m′= . . . m′_{w+1}m′_{w}11 . . . 1 and m′=mx for some W-bit number x. In binary notations these conditions take the following form:

| . . . | m_{w-1}x₀ | m_{w-2}x₀ | . . . | m₃x₀ | m₂x₀ | m₁x₀ | x₀ |
|---|---|---|---|---|---|---|---|
| . . . | m_{w-2}x₁ | m_{w-3}x₁ | . . . | m₂x₁ | m₁x₁ | x₁ | 0 |
| . . . | m_{w-3}x₂ | m_{w-4}x₂ | . . . | m₁x₂ | x₂ | 0 | 0 |

. . .

| | | | | | | | |
|---|---|---|---|---|---|---|---|
| . . . | x_{w-1} | 0 | . . . | 0 | 0 | 0 | 0 |
| . . .m′_{w} | 1 | 1 | . . . | 1 | 1 | 1 | 1 |

Therefore, x₀=1, x₁= [symbol] m₁, x₂= [symbol] m₂, x₃=m₁⊕m₂⊕ [symbol] m₃, . . . In general, xₖ= [symbol] mₖ⊕Fₖ(xₖ₋₁, . . . , x₀), for some Fₖ.

The following algorithm computes both m′ and x in W−1 steps:

Input: m.

Output: m′ and x.

(i) A=m, X=1, x=0

(ii) For k=1 to W−1: X←X+2^{k} [symbol] Aₖ; A←A+m2^{k} [symbol] Aₖ;

(iii) m′=A, x=X.

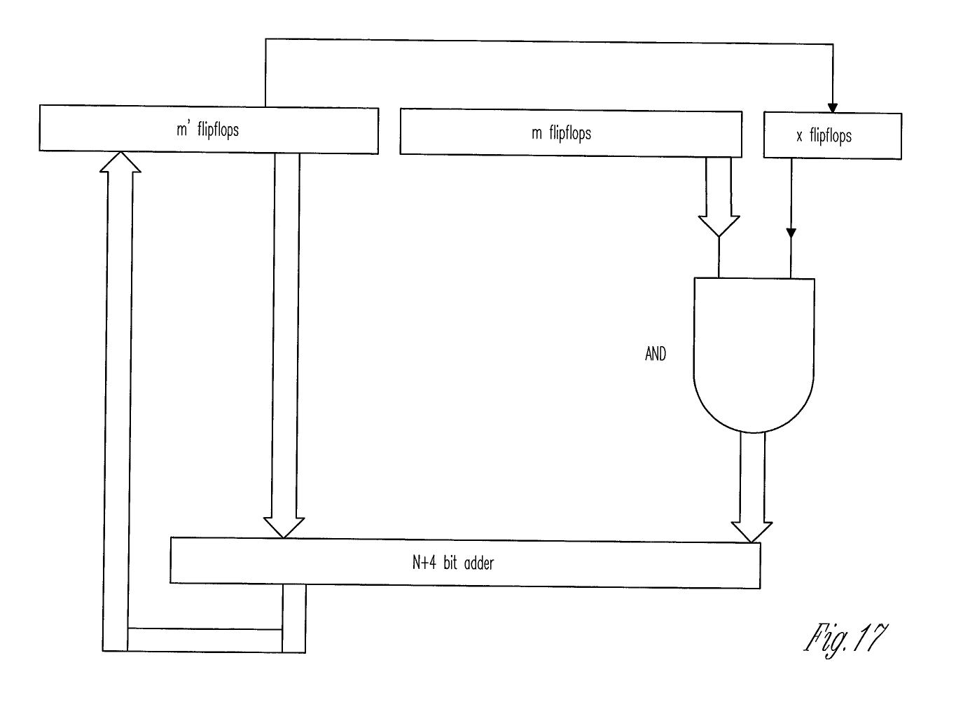

This algorithm can be implemented using a single adder (an adder which is a part of the Montgomery Multiplier itself can be used). An appropriate implementation scheme is shown on FIG. 17.

In addition to or alternatively to the modification of the W least significant bits of the modulus m as described hereinabove with reference to FIGS. 16 and 17, another embodiment of the present invention provides for the setting of the W+1 to 2W least significant bits to 0 in the modulus to form a modified modulus m′. Thus in an embodiment employing the previously described technique and this embodiment, the modified modulus m′ would have the W least significant bits set to 1 and the W+1 to 2W least significant bits set to 0. The reason for this is that by setting the W+1 to 2W least significant bits to 0, the size of the array to be combined by the combination logic in the Λ logic unit, i.e. the parallel counter is reduced since a product of Λ x modulus for the W+1 to 2W bits is 0. For example, referring to the embodiment described hereinabove for W=2, in the arrays, if such a technique were employed m₂ and m₃ would be set to 0 and thus the third column from the left (i.e. the (W+1)^{th} bit) has one less value since λ₁m₂=0 and the fourth column from the left (i.e. the (2W)^{th} bit) has two less values since λ₁m₃ and λ₂m₂ are 0.

Thus this reduction in the size of the array for the 2W least significant bits used by the reduction logic in the calculation of Λ for the next cycle enables a calculation of Λ for when W is large to be performed faster. The trade off is that the factor by which the modulus is multiplied is a larger number. Thus, the subtract/compare module 55 has to perform more computations to subtract m from the output. Since the modulus m is multiplied by a number between 0 and (2^{2W}−1) the subtract/compare module 55 has to subtract m off from the output anything from 0 to (2^{2W}−1) times. This increases the amount of processing required by the subtract/compare module 55. The process is however outside the exponential loop in the processing and thus for large Ws this can provide for improved speed of processing.

In this embodiment of the present invention, any logic having the same effect as the removal of m up to 2^{W-1} times can be used. Thus, a Montgomery multiplier can replace the Montgomery multiplier 54 and subtract/compare module 55, wherein the Montgomery multiplier has the output of the A register 53 as an input, 1 as a second input, and the modulus input is the original modulus m. The present invention encompasses any method of reducing the output to be less than the unmodified modulus.

In a further embodiment of the present invention, another method of speeding up the computation of Λ is to pre-compute the triangular part of the xy array for bits W to 2W. As can be seen in the example given hereinabove for W=2, the two input rows input three values. These values are known and hence the combination can be pre-computed in a previous loop of the processing in order to generate a combination of the inputs, i.e. a single row (i.e. a single multi-bit binary number). Thus logic can be provided for providing the W rows for the bits 1 to 2W in a cycle for use as a single input row (or W bit binary value) in the next cycle for use in the calculation of Λ.

The advantage of this is that when W is large, large parallel counters are required in the Λ logic. Using this technique separate logic can be provided to pre-compute the sum of these W rows to reduce the size of the parallel counters required in the Λ logic. The trade off in this embodiment is that separate logic is required for the pre-computation of the sum of the rows, i.e. the sum of 2W least significant bits of the W input multi-bit binary combination values.

Although the modular exponentiation process has been described with reference to the embodiments in which the Montgomery multiplier is used sequentially in the exponentiation process, the present invention is not limited to this arrangement. For example the present invention encompasses any configuration of Montgomery multipliers for performing the exponentiation process e.g. a parallel arrangement.

The present invention can be implemented using any design method such as standard cells, wherein standard cells can be designed specifically for implementation in the logic circuit. Thus the invention encompasses a method and system for designing the standard cells, e.g. a computer system implementing computer code, and a method and system for designing a logic circuit using the standard cells, e.g. a computer system implementing computer code. The standard cells can be represented after their design as code defining characteristics of the standard cells. This code can then be used by a logic circuit design program for the design of the logic circuit. The end result of the design of the logic circuit can comprise code defining the characteristics of the logic circuit. This code can then be passed to a chip manufacturer to be used in the manufacture of the logic circuit in semiconductor material, e.g. silicon.

It is known in digital electronics that standard cell implementations of circuits are cheaper and faster to produce than other means, for example full custom implementations. A standard cell array design employs a library of pre-characterized custom designed cells which are optimized for silicon area and performance. The cells are designed to implement a specific function. Thus the design of a circuit using standard cells requires the choosing of a set of standard cells from the library which, when connected together form the required function. Cells are normally designed to have a uniform height with variable width when implemented in silicon. It is known in standard cell design that logic functions can be combined in a single standard cell to reduce area, reduce power consumption, and increase speed.

The present invention encompasses the use of standard cell techniques for the design and implementation of logic circuits in accordance with the present invention.

The present invention encompasses a standard cell design process in which a design program is implemented by a designer in order to design standard cells which implement either the complete logic function of the Montgomery multiplier in accordance with the present invention, or functions which comprise parts of the Montgomery multiplier or modular exponentiator. The design process involves designing, building and testing the standard cells in silicon and the formation of a library of data characterizing the standard cells which have been successfully tested. This library of data characterizing standard cell designs contains information which can be used in the design of a logic circuit using the standard cells. The data or code in the library thus holds characteristics for the logic circuit which defines a model of the standard cell. The data can include geometry, power, and timing information as well as a model of the function performed by the standard cell. Thus a vender of standard cell designs can make the library of standard cell code available to logic circuit designers to facilitate the designing of logic circuits to perform specific functions using the functionality of the library of standard cells. Thus a logic circuit designer can use the library of code for standard cells in a computer modelling implementation to assemble a logic circuit using the standard cell code. The designer therefore implements a design application which uses the code to build the model of the desired logic circuit. The resultant data defines the characteristics of the logic circuit, in terms of a combination of standard cells. This data can thus be used by a chip manufacturer to design and build the chip using the model data generated by the logic circuit designer.

The present invention encompasses the design of standard cells for implementing the functions in accordance with the present invention, i.e. the generation of model data defining the characteristics of standard cells implementing the inventive functions. The present invention also encompasses the method of designing the inventive logic circuit using the library of standard cell data, i.e. the steps of using a computer program to generate data modelling the characteristics of the inventive logic circuit. The present invention also encompasses the process of manufacturing the logic circuit using the design data.

The standard cells designed can implement the complete functionality of the logic circuit or the functionality of a sub-unit. Thus the logic circuit can be designed either to be implemented by a single standard cell, or by the combination of a plurality of standard cells. Standard cells can be designed to implement any level of functionality of sub-units within the logic circuit.

The present invention further encompasses any method of designing and manufacturing any inventive logic circuit as hereinabove described. The invention further encompasses code or data characterizing the inventive logic circuit. Also, the present invention encompasses code for modelling the inventive functionality of the logic circuit as hereinabove described.

The code for designing, and the code for defining characteristics or functions of the standard cells or logic circuit can be made available on any suitable carrier medium such as a storage medium, e.g. a floppy disk, hard disk, CD-ROM, tape device or solid state memory device, or a transient medium such as any type of signal, e.g. an electric signal, optical signal, microwave signal, acoustic signal or a magnetic signal (e.g. a signal carried over a communications network).

Although the present invention has been described hereinabove with reference to specific embodiments, it will be apparent to a skilled person in the art that modifications lie within the spirit and scope of the present invention.

The logic circuits of the embodiments of the present invention described hereinabove can be implemented in an integrated circuit, or in any digital electronic device.

What is claimed is:

1. A logic circuit for performing modular multiplication of a first multi-bit binary value and a second multi-bit binary value, the logic circuit comprising:
input combination logic for receiving and combining the second multi-bit binary value and a group of W bits of the first multi-bit binary value every j^{th} input cycle to generate W multi-bit binary combination values every j^{th} input cycle, where the W bits comprise bits jW to (jW+W−1), W>1, j is the cycle index from 0 to k−1, k=N/W, and N is the number of bits of the first multi-bit binary value;
accumulator logic for holding a plurality of multi-bit binary values accumulated over previous cycles;
reduction logic for generating a W bit value Λ in a current cycle for use in the next cycle, for receiving a multi-bit modulus binary value, and for combining the multi-bit modulus binary value with a W bit value Λ generated in a current cycle to generate W multi-bit binary values for use in the next cycle;
combination logic connected to said input combination logic, said accumulator logic, and said reduction logic, and for combining the W multi-bit binary combination values generated by said input combination logic in the current cycle, the W multi-bit binary values generated by said reduction logic in the current cycle, and the multi-bit binary values held by said accumulator logic to generate a plurality of new multi-bit binary values for input to said accumulator logic to be held in the next cycle;
wherein said reduction logic is arranged to generate the W bit value Λ for the next cycle based on the multi-bit modulus binary value, the multi-bit binary values held in the accumulator logic, W multi-bit binary combination values generated by combination of the second multi-bit binary value and a group of W bits of the first multi-bit binary value in the current cycle, and the W bit value Λ generated for the current cycle.

2. A logic circuit according to claim 1, wherein said reduction logic is arranged to generate the W bit value Λ for the next cycle to make the W least significant bits of the plurality of new multi-bit binary values generated by the combination logic in the next cycle zero, and said combination logic includes shift logic to shift the generated new multi-bit binary values by W bits before input to said accumulator logic.

3. A logic circuit according to claim 1, wherein said reduction logic is arranged to generate the W bit value Λ for the next cycle based on the 2W least significant bits of the multi-bit modulus binary value, the 2W least significant bits of the multi-bit binary values held in said accumulator logic in the current cycle, the jW to (jW+W−1) bits of the W multi-bit binary combination values generated by combination of the second multi-bit binary value and a group of W bits of the first multi-bit binary value in the current cycle, and the W bit value Λ generated by said generation logic for the current cycle.

4. A logic circuit according to claim 2, wherein said reduction logic is arranged to generate the W bit value Λ for the next cycle based on the 2W least significant bits of the multi-bit modulus binary value, the 2W least significant bits of the multi-bit binary values held in said accumulator logic in the current cycle, the jW to (jW+W−1) bits of the W multi-bit binary combination values generated by combination of the second multi-bit binary value and a group of W bits of the first multi-bit binary value in the current cycle, and the W bit value Λ generated by said generation logic for the current cycle.

5. A logic circuit according to claim 3, including pre-combination logic for receiving and combining the second multi-bit binary value and the jW to (jW+W−1) bits of the first multi-bit binary value in the current cycle to generate the W multi-bit binary combination values for input to said reduction logic for use in the next cycle.

6. A logic circuit according to claim 4, including pre-combination logic for receiving and combining the second multi-bit binary value and the jW to (jW+W−1) bits of the first multi-bit binary value in the current cycle to generate the W multi-bit binary combination values for input to said reduction logic for use in the next cycle.

7. A logic circuit according to claim 1, wherein said input combination logic is connected to said reduction logic to input the W multi-bit binary combination value to said reduction logic.

8. A logic circuit according to claim 1, wherein the reduction logic includes further input combination logic for receiving and combining the W multi-bit binary combination values in the current cycle to generate a single multi-bit binary combination value for use in the next cycle.

9. A logic circuit according to claim 1, wherein said combination logic is arranged to multiply the second multi-bit binary value and the group of W bits of the first multi-bit binary value every j^{th} input cycle to generate the W multi-bit binary combination values every j^{th} input cycle.

10. A logic circuit according to claim 9, wherein said combination logic comprises an array of AND logic gates.

11. A logic circuit according to claim 8, wherein said further input combination logic is arranged to multiply the second multi-bit binary value and the group of W bits of the first multi-bit binary value every j^{th} input cycle to generate the W multi-bit binary combination values every j^{th} input cycle.

12. A logic circuit according to claim 11, wherein said further input combination logic comprises an array of AND logic gates.

13. A logic circuit according to claim 5, wherein said pre-combination logic is arranged to multiply the second multi-bit binary value and the jW to (jW+jW−1) bits of the first multi-bit binary value in the current cycle to generate the W multi-bit binary combination values for input to the reduction logic for use in the next cycle.

14. A logic circuit according to claim 6, wherein said pre-combination logic is arranged to multiply the second multi-bit binary value and the jW to (jW+jW−1) bits of the first multi-bit binary value in the current cycle to generate the W multi-bit binary combination values for input to the reduction logic for use in the next cycle.

15. A logic circuit according to claim 13, wherein said pre-combination logic comprises an array of AND logic gates.

16. A logic circuit according to claim 14, wherein said pre-combination logic comprises an array of AND logic gates.

17. A logic circuit according to claim 1, wherein said reduction logic is arranged to multiply the multi-bit modulus binary value with the W bit value Λ generated in a current cycle to generate W multi-bit binary values for use in the next cycle.

18. A logic circuit according to claim 17, wherein said reduction logic includes an array of AND gate logic for performing the multiplication.

19. A logic circuit according to claim 1, wherein said combination logic includes a plurality of parallel counters for performing the combination.

20. A logic circuit according to claim 19, wherein said parallel counters are arranged to each receive a corresponding bit of: the W multi-bit binary combination values generated by said input combination logic in the current cycle, the W multi-bit binary values generated by said reduction logic in the current cycle, and the multi-bit binary values held by said accumulator logic.

21. A logic circuit according to claim 19, wherein each parallel counter has (2W+R) inputs and R outputs, where R is the number of new multi-bit binary values input to said accumulator logic to be held in the next cycle.

22. A logic circuit according to claim 1, wherein said accumulator logic comprises an array of flip-flops, each flip-flop receiving a bit of one of the new multi-bit binary values output from said combination logic.

23. A logic circuit according to claim 1, wherein said reduction logic comprises high speed logic components to generate the W bit binary value Λ during the current cycle for use in the next cycle.

24. A logic circuit according to claim 1, wherein said reduction logic includes a plurality of parallel counters for generating the W bit binary value Λ.

25. A logic circuit according to claim 1, including final reduction logic for summing the plurality of new multi-bit binary values output from said combination logic at the end of the (k−1)^{th} cycle and for subtracting the multi-bit modulus binary value from the sum if the sum is greater than or equal to the multi-bit modulus binary value.

26. A logic circuit according to claim 1, wherein the multi-bit modulus binary value is an odd number.

27. A logic circuit according to claim 1, wherein the logic circuit is arranged to perform Montgomery multiplication.

28. A logic circuit according to claim 1, wherein said input combination logic, said accumulator logic and said combination logic are formed of a plurality of logic elements, one for each input bit of the W multi-bit binary combination values.

29. A logic circuit according to claim 28, wherein said combination logic comprises a parallel counter in each said logic element.

30. A logic circuit according to claim 28, wherein said accumulator logic comprises an array of flip-flops in each said logic element.

31. A logic circuit according to claims 28, wherein said input combination logic comprises an array of AND gates in each logic element.

32. A logic circuit according to claim 28, wherein said logic elements comprise standard cells.

33. A logic circuit according to claim 1, including modulus modifying logic for initially modifying the multi-bit modulus binary value used by the logic circuit by a factor to make the W least significant bits ones.

34. A logic circuit according to claim 1, wherein said modulus modifying logic is arranged to initially modify the multi-bit modulus binary value to make the W to 2W−1 bits zeros.

35. A logic circuit according to claim 33 or claim 34, including final reduction logic for summing the plurality of new multi-bit binary values output from said combination logic at the end of the (k−1)^{th} cycle, and for performing a function equivalent to comparing the sum and the multi-bit modulus binary value and, if the sum is greater or equal to the multi-bit modulus binary value, subtracting the multi-bit modulus binary value from the sum, and repeating the comparison and subtraction until the sum is less than the multi-bit modulus binary value.

36. A modular exponentiation logic circuit for performing modular exponentiation, comprising:
input logic for receiving a multi bit binary value to be exponentiated, a multi bit binary exponent, and a multi bit modulus binary value;
at least one logic circuit for performing modular multiplication of a first multi-bit binary value and a second multi-bit binary value, each logic circuit comprising:
input combination logic for receiving and combining the second multi-bit binary value and a group of W bits of the first multi-bit binary value every j^{th} input cycle to generate W multi-bit binary combination values every j^{th} input cycle, where the W bits comprise bits jW to (jW+W−1), W>1, j is the cycle index from 0 to k−1, k=N/W, and N is the number of bits of the first multi-bit binary value;
accumulator logic for holding a plurality of multi-bit binary values accumulated over previous cycles;
reduction logic for generating a W bit value Λ in a current cycle for use in the next cycle, for receiving a multi-bit modulus binary value, and for combining the multi-bit modulus binary value with a W bit value Λ generated in a current cycle to generate W multi-bit binary values for use in the next cycle;
combination logic connected to said input combination logic, said accumulator logic, and said reduction logic, and for combining the W multi-bit binary combination values generated by said input combination logic in the current cycle, the W multi-bit binary values generated by said reduction logic in the current cycle, and the multi-bit binary values held by said accumulator logic to generate a plurality of new multi-bit binary values for input to said accumulator logic to be held in the next cycle;
wherein said reduction logic is arranged to generate the W bit value Λ for the next cycle based on the multi-bit modulus binary value, the multi-bit binary values held in the accumulator logic, W multi-bit binary combination values generated by combination of the second multi-bit binary value and a group of W bits of the first multi-bit binary value in the current cycle, and the W bit value Λ generated for the current cycle; and
said modular exponentiation logic circuit includes logic for inputting the multi bit binary number to be exponentiated and/or a multi bit binary number based on an output of at least one said logic circuit into at least one said logic circuit in dependence upon the multi bit binary exponent, and for forming a multi bit binary value comprising the modular exponentiation of the multi bit binary number to be exponentiated on the basis on an output of the or each said logic circuit.

37. A modular exponentiation logic circuit according to claim 36, wherein said reduction logic is arranged to generate the W bit value Λ for the next cycle to make the W least significant bits of the plurality of new multi-bit binary values generated by the combination logic in the next cycle zero, and said combination logic includes shift logic to shift the generated new multi-bit binary values by W bits before input to said accumulator logic.

38. A modular exponentiation logic circuit according to claim 36, wherein said reduction logic is arranged to generate the W bit value Λ for the next cycle based on the 2W least significant bits of the multi-bit modulus binary value, the 2W least significant bits of the multi-bit binary values held in said accumulator logic in the current cycle, the jW to (jW+W−1) bits of the W multi-bit binary combination values generated by combination of the second multi-bit binary value and a group of W bits of the first multi-bit binary value in the current cycle, and the W bit value Λ generated by said generation logic for the current cycle.

39. A modular exponentiation logic circuit according to claim 38, including pre-combination logic for receiving and combining the second multi-bit binary value and the jW to (jW+W−1) bits of the first multi-bit binary value in the current cycle to generate the W multi-bit binary combination values for input to said reduction logic for use in the next cycle.

40. A modular exponentiation logic circuit according to claim 36, wherein said input combination logic is connected to said reduction logic to input the W multi-bit binary combination value to said reduction logic.

41. A modular exponentiation logic circuit according to claim 36, wherein the reduction logic includes further input combination logic for receiving and combining the W multi-bit binary combination values in the current cycle to generate a single multi-bit binary combination value for use in the next cycle.

42. A modular exponentiation logic circuit according to claim 36, wherein said combination logic is arranged to multiply the second multi-bit binary value and the group of W bits of the first multi-bit binary value every j^{th} input cycle to generate the W multi-bit binary combination values every j^{th} input cycle.

43. A modular exponentiation logic circuit according to claim 42, wherein said combination logic comprises an array of AND logic gates.

44. A modular exponentiation logic circuit according to claim 41, wherein said further input combination logic is arranged to multiply the second multi-bit binary value and the group of W bits of the first multi-bit binary value every j^{th} input cycle to generate the W multi-bit binary combination values every j^{th} input cycle.

45. A modular exponentiation logic circuit according to claim 44, wherein said further input combination logic comprises an array of AND logic gates.

46. A modular exponentiation logic circuit according to claim 39, wherein said pre-combination logic is arranged to multiply the second multi-bit binary value and the jW to (jW+jW−1) bits of the first multi-bit binary value in the current cycle to generate the W multi-bit binary combination values for input to the reduction logic for use in the next cycle.

47. A modular exponentiation logic circuit according to claim 46, wherein said pre-combination logic comprises an array of AND logic gates.

48. A modular exponentiation logic circuit according to claim 36, wherein said reduction logic is arranged to multiply the multi-bit modulus binary value with the W bit value Λ generated in a current cycle to generate W multi-bit binary values for use in the next cycle.

49. A modular exponentiation logic circuit according to claim 48, wherein said reduction logic includes an array of AND gate logic for performing the multiplication.

50. A modular exponentiation logic circuit according to claim 36, wherein said combination logic includes a plurality of parallel counters for performing the combination.

51. A modular exponentiation logic circuit according to claim 50, wherein said parallel counters are arranged to each receive a corresponding bit of: the W multi-bit binary combination values generated by said input combination logic in the current cycle, the W multi-bit binary values generated by said reduction logic in the current cycle, and the multi-bit binary values held by said accumulator logic.

52. A modular exponentiation logic circuit according to claim 50, wherein each parallel counter has (2W+R) inputs and R outputs, where R is the number of new multi-bit binary values input to said accumulator logic to be held in the next cycle.

53. A modular exponentiation logic circuit according to claim 36, wherein said accumulator logic comprises an array of flip-flops, each flip-flop receiving a bit of one of the new multi-bit binary values output from said combination logic.

54. A modular exponentiation logic circuit according to claim 36, wherein said reduction logic comprises high speed logic components to generate the W bit binary value Λ during the current cycle for use in the next cycle.

55. A modular exponentiation logic circuit according to claim 36, wherein said reduction logic includes a plurality of parallel counters for generating the W bit binary value Λ.

56. A modular exponentiation logic circuit according to claim 36, including final reduction logic for summing the plurality of new multi-bit binary values output from said combination logic at the end of the (k−1)^{th} cycle and for subtracting the multi-bit modulus binary value from the sum if the sum is greater than or equal to the multi-bit modulus binary value.

57. A modular exponentiation logic circuit according to claim 36, wherein the multi-bit modulus binary value is an odd number.

58. A modular exponentiation logic circuit according to claim 36, wherein the logic circuit is arranged to perform Montgomery multiplication.

59. A modular exponentiation logic circuit according to claim 36, wherein said input combination logic, said accumulator logic and said combination logic are formed of a plurality of logic elements, one for each input bit of the W multi-bit binary combination values.

60. A modular exponentiation logic circuit according to claim 59, wherein said combination logic comprises a parallel counter in each said logic element.

61. A modular exponentiation logic circuit according to claim 59, wherein said accumulator logic comprises an array of flip-flops in each said logic element.

62. A modular exponentiation logic circuit according to claims 59, wherein said input combination logic comprises an array of AND gates in each logic element.

63. A modular exponentiation logic circuit according to claim 59, wherein said logic elements comprise standard cells.

64. A modular exponentiation logic circuit according to claim 36, including initial input logic for initially inputting a multi bit binary value 2^{2N}|mod m into at least one said logic circuit, where m is a multi bit binary modulus value and N is the number of bits of the multi bit binary value to be exponentiated.

65. A modular exponentiation logic circuit according to claim 64, wherein at least one said logic circuit is arranged to receive the multi bit binary value 2^{2N}|mod m and the multi bit binary value to be exponentiated as initial inputs.

66. A modular exponentiation logic circuit according to claim 65, wherein a said logic circuit is arranged to receive a final output of at least one said logic circuit and logic one as inputs to generate the multi bit binary value comprising the modular exponentiation of the multi bit binary number to be exponentiated.

67. A modular exponentiation logic circuit according to claim 36, including modulus modifying logic for initially modifying the multi-bit modulus binary value used by the modular exponentiation logic circuit by a factor to make the W least significant bits ones.

68. A modular exponentiation logic circuit according to claim 36, wherein said modulus modifying logic is arranged to initially modify the multi-bit modulus binary value to make the W to 2W-1 bits zeros.

69. A modular exponentiation logic circuit according to claim 67, including final reduction logic for modifying the multi bit binary value comprising the modular exponentiation of the multi bit binary number to be exponentiated to be less than the unmodified multi-bit modulus binary value.

70. A modular exponentiation logic circuit according to claim 68, including final reduction logic for modifying the multi bit binary value comprising the modular exponentiation of the multi bit binary number to be exponentiated to be less than the unmodified multi-bit modulus binary value.

71. A modular exponentiation logic circuit according to claim 69, wherein the final reduction logic is arranged to compare an output of at least one said logic circuit and the multi-bit modulus binary value and, if the output is greater or equal to the multi-bit modulus binary value, to subtract the multi-bit modulus binary value from the sum, and to repeat the comparison and subtraction until the output is less than the multi-bit modulus binary value.

72. A modular exponentiation logic circuit according to claim 70, wherein the final reduction logic is arranged to compare an output of at least one said logic circuit and the multi-bit modulus binary value and, if the output is greater or equal to the multi-bit modulus binary value, to subtract the multi-bit modulus binary value from the sum, and to repeat the comparison and subtraction until the output is less than the multi-bit modulus binary value.

73. An encryption logic circuit for encrypting or decrypting a multi-bit binary value comprising the logic circuit according to any claim 1 or claim 36.

74. An RSA encryption circuit for RSA encrypting or decrypting a multi-bit binary value comprising the logic circuit according to any claim 1 or 36.

75. An integrated circuit comprising the logic circuit according to claim 1 or 36.

76. An electronic device comprising the logic circuit according to claim 1 or 36.

77. A carrier medium carrying code defining characteristics of the logic circuit according to any one of claims 1 to 35.

78. A method of designing a logic circuit according to any one of claims 1 to 35, comprising implementing a computer program to generate information defining characteristics of the logic circuit.

79. A carrier medium carrying computer readable code for controlling a computer to implement the method of designing a logic circuit according to any one of claims 1 to 35 which comprises implementing a computer code to generate information defining characteristics of the logic circuit.

80. A design system for designing a logic circuit according to any one of claims 1 to 35, comprising a computer system for generating information defining characteristics of the logic circuit.

81. A method of manufacture of a logic circuit according to any one of claims 1 to 35, comprising designing and building the logic circuit in semiconductor material in accordance with code defining characteristics of the logic circuit.

82. A logic circuit for performing Montgomery multiplication between a first multi-bit binary value and a second multi-bit binary value, comprising:
input logic for inputting W multi-bit combination binary values comprised of the combination X_{jW}Yᵢ to X_{(jW+W-1)}Yᵢ ofjW to (jW+W−1) bits of the first binary value X and i bits of the second multi-bit binary value, where j is the processing cycle from 0 to k−1, k=N/W, W>1, and N is the number of bits of the first multi-bit binary value;
accumulator logic for accumulating at least one multi-bit binary value A in a current cycle on the basis of multi-bit binary values in the accumulator in a previous cycle, and the input W multi-bit combination binary values; and
reduction logic for generating a W bit binary value Λ for a current cycle such that Λ=A|mod2^{W}, wherein said accumulator logic is arranged to update said at least one accumulated multi-bit binary value A for a current cycle by adding the product of the generated W bit binary value Λ and a multi-bit binary modulus value and dividing the result by 2^{W}.

83. A logic circuit according to claim 82, including final reduction logic for determining a Montgomery product by subtracting the multi-bit binary modulus value from the accumulated multi-bit binary value or the sum of the accumulated multi-bit binary values if the accumulated multi-bit binary value or the sum of the accumulated multi-bit binary values is greater than or equal to the multi-bit binary modulus value.

84. A logic circuit according to claim 82, wherein said accumulator logic is arranged to accumulate said at least one multi-bit binary value A in a current cycle as A+X_{jW}Yᵢ+2X_{jW+1}Yᵢ+ . . . +2^{X-W}X_{(jW+W-1)}Yᵢ.

85. A logic circuit according to claim 82, wherein said reduction logic is arranged to determined the W bit binary value for the next cycle based on the W bit binary value for the current cycle, said at least one accumulated multi-bit binary value in said accumulator logic in the current cycle, the multi-bit binary modulus value, and the input W multi-bit combination binary values in the current cycle.

86. A logic circuit according to claim 83, wherein said reduction logic is arranged to determined the W bit binary value for the next cycle based on the W bit binary value for the current cycle, said at least one accumulated multi-bit binary value in said accumulator logic in the current cycle, the multi-bit binary modulus value, and the input W multi-bit combination binary values in the current cycle.

87. A logic circuit according to claim 82, wherein said reduction logic and said accumulator logic are arranged to operate in parallel during a cycle.

88. A modular exponentiation logic circuit for performing modular exponentiation, comprising:
input logic for receiving a multi bit binary value to be exponentiated, a multi bit binary exponent, and a multi bit modulus binary value; and
at least one logic circuit for performing Montgomery multiplication between a first multi-bit binary value and a second multi-bit binary value, each logic circuit comprising:
input logic for inputting W multi-bit combination binary values comprised of the combination X_{jW}Yᵢ to X_{(jW+W-1)}Yᵢ of jW to (jW+W−1) bits of the first binary value X and i bits of the second multi-bit binary value, where j is the processing cycle from 0 to k−i, k=N/W, W>1, and N is the number of bits of the first multi-bit binary value;
accumulator logic for accumulating at least one multi-bit binary value A in a current cycle on the basis of multi-bit binary values in the accumulator in a previous cycle, and the input W multi-bit combination binary values; and
reduction logic for generating a W bit binary value Λ for a current cycle such that Λ=A|mod2^{W}, wherein said accumulator logic is arranged to update said at least one accumulated multi-bit binary value A for a current cycle by adding the product of the generated W bit binary value Λ and a multi-bit binary modulus value and dividing the result by 2^{W}.

89. A modular exponentiation logic circuit according to claim 88, including final reduction logic for determining a Montgomery product by subtracting the multi-bit binary modulus value from the accumulated multi-bit binary value or the sum of the accumulated multi-bit binary values if the accumulated multi-bit binary value or the sum of the accumulated multi-bit binary values is greater than or equal to the multi-bit binary modulus value.

90. A modular exponentiation logic circuit according to claim 88, wherein said accumulator logic is arranged to accumulate said at least one multi-bit binary value A in a current cycle as A+X_{jW}Yᵢ+2X_{jW}+1Yᵢ+ . . . +2^{W-1}X_{(jW+W-1)}Yᵢ.

91. A modular exponentiation logic circuit according to claim 88, wherein said reduction logic is arranged to determined the W bit binary value for the next cycle based on the W bit binary value for the current cycle, said at least one accumulated multi-bit binary value in said accumulator logic in the current cycle, the multi-bit binary modulus value, and the input W multi-bit combination binary values in the current cycle.

92. A modular exponentiation logic circuit according to claim 89, wherein said reduction logic is arranged to determined the W bit binary value for the next cycle based on the W bit binary value for the current cycle, said at least one accumulated multi-bit binary value in said accumulator logic in the current cycle, the multi-bit binary modulus value, and the input W multi-bit combination binary values in the current cycle.

93. A modular exponentiation logic circuit according to claim 88, wherein said reduction logic and said accumulator logic are arranged to operate in parallel during a cycle.

94. A modular exponentiation logic circuit according to claim 88, including modulus modifying logic for initially modifying the multi-bit modulus binary value used by the modular exponentiation logic circuit by a factor to make the W least significant bits ones.

95. A modular exponentiation logic circuit according to claim 94, wherein said modulus modifying logic is arranged to initially modify the multi-bit modulus binary value to make the 2W to 2W−1 bits zeros.

96. A modular exponentiation logic circuit according to claim 94, including final reduction logic for modifying the multi bit binary value comprising the modular exponentiation of the multi bit binary number to be exponentiated to be less than the unmodified multi-bit modulus binary value.

97. An encryption logic circuit for encrypting or decrypting a multi-bit binary value comprising the logic circuit according to any one of claims 82 to 96.

98. An RSA encryption circuit for RSA encrypting or decrypting a multi-bit binary value comprising the logic circuit according to claim 82.

99. An integrated circuit comprising the logic circuit according to claim 82.

100. An electronic device comprising the logic circuit according to claim 82.

101. A carrier medium carrying code defining characteristics of the logic circuit according to any one of claims 82 to 96.

102. A method of designing a logic circuit according to any one of claims 82 to 96, comprising implementing a computer program to generate information defining characteristics of the logic circuit.

103. A carrier medium carrying computer readable code for controlling a computer to implement the method of designing a logic circuit according to any one of claims 82 to 96 which comprises implementing the computer code to generate information defining characteristics of the logic circuit.

104. A design system for designing a logic circuit according to any one of claims 82 to 96, comprising a computer system for generating information defining characteristics of the logic circuit.

105. A method of manufacture of a logic circuit according to any one of claims 82 to 96, comprising designing and building the logic circuit in semiconductor material in accordance with the code defining characteristics of the logic circuit.

106. A logic circuit for performing modular multiplication, comprising:
a logic input for accessing combinations of two binary inputs to input W multi-bit binary combinations of two binary numbers, where W>1;
accumulator logic for accumulating multi-bit binary values;
combining logic for combining the input W multi-bit binary combinations and the values in the accumulator logic to generate new values for input to the accumulator logic; and
reduction logic for determining a W bit binary value A|mod 2^{W}, for receiving a multi-bit modulus binary value, and for generating W multi-bit binary values using the W bit binary value and the modulus binary value;
wherein said combination logic is arranged to generate the new values by also including the generated W multi-bit binary values.
